(19) United States
(12) Patent Application Publication
(10) Pub. No.: US 2001/0056412 A1
(43) Pub. Date: Dec. 27, 2001

(54) Transaction Intermediary apparatus, method and system with negotiation capability for transaction of goods or services through communication network

(76) Inventors: Toru Kutsuzawa, Tokyo (JP); Hiroto Hayashi, Tokyo (JP)

Correspondence Address: MURAMATSU & ASSOCIATES, Suite 225, 7700 Irvine Center Drive, Irvine, TX, 92618, US

(21) Appl. No.: 09/776,424

(22) Filed: Feb. 2, 2001

(30) Foreign Application Priority Data
Jun. 23, 2000 (JP) 2000-188574

(51) Int. Cl. G06F 17/60

(52) U.S. Cl. 705/80; 705/5; 705/37

(57) ABSTRACT

A transaction intermediary apparatus, system and method with a negotiation capability promote trade of goods or services between buyers and sellers for achieving buyer driven transactions including transactions resulted from negotiation requests initiated by buyers. The apparatus receives first and second offer data of goods or services provided by sellers where the second offer data has conditions more beneficial to buyers in price or quality than that of the first offer data. The apparatus receives purchase conditions requested by a buyer and offers, in response, the first offer data to the buyer, receives a negotiation request from the buyer, and offers the second offer data in response to the negotiation request.

### FIELD OF THE INVENTION

The present invention relates to a transaction intermediary apparatus and method and a transaction intermediary system to act as an intermediary in business transactions over a communication network, and more particularly, to a transaction intermediary apparatus and method and a transaction intermediary system using a communication network for exchanging information between buyers and sellers including dynamic negotiations, especially, buyer-driven negotiations, to achieve business transaction favorable to buyers.

### BACKGROUND OF THE INVENTION

Due to the advancement of communication technologies such as Internet and world wide web (WWW), commercial transaction dealing with goods and services today is changing dramatically. The advantages of commercial transaction using the Internet is, firstly, many middlemen between buyers and sellers are no longer required. Secondary, since buyers can purchase or reserve goods and services through the communication network, physical stores to display and invite customers are unnecessary.

One manifestation of such a commercial transaction is so-called “a reverse auction method” disclosed in the U.S. Pat. No. 5,794,207, that has a style inverse to the traditional style of auction between sellers and buyers for goods or services.

More particularly, a normal auction proceeds in the following steps. First, an intermediary between the seller and the buyer announces the start of auction with a relatively low price. The buyer announces a price higher than that raised by the intermediary. Another buyer then announces a price still higher than the predecessor's price. Repeating this procedure increases the price continuously, while the number of buyers gradually decreases. Then, the intermediary sells the goods to the highest bidder. Alternatively, a seller may announce the price to invite buyers to pronounce the item to be sold without involving an intermediary. In this manner, in the normal auction, there is only one (1) seller, while there are a plurality of buyers, and accordingly, the seller has the power to determine the final deal.

On the other hand, in the “reverse-auction method” described in the U.S. Pat. No. 5,794,207, the buyer has the power to determine the price. In this method, it is presumed that a plurality of sellers exist for one (1) buyer. Thus, the buyer announces his/her desired purchase price. An intermediary (service provider) notifies the desired price to the plurality of sellers through the communication network. Each seller offers a price determined by considering the buyer's desired purchase price. The intermediary notifies the result to the buyer to complete the transaction.

In principle, the “reverse auction method” in the U.S. Pat. No. 5,794,207 is similar to a normal commercial transaction in that the buyer obtains estimates from a plurality of sellers to select a seller that can offer buyer's preference. In the reverse auction, by using the communication network, the service provider acts as an intermediary. By prompting the buyer to input the account number of a credit card or its equivalent upon entering the buyer's desired purchase price, the payment is ensured. The transaction is established when the seller agrees to sell or intermediary selects a seller from the plurality of sellers. In this regard, the U.S. Pat. No. 5,794,207 provides a new method of commercial transaction.

However, the “reverse auction method” has the following drawbacks. The buyer is bound by the term such as a price responded from the seller. Thus, if the response that matches the condition requested by the seller exists, the transaction such as purchase or reservation is automatically completed. The buyer cannot compare the conditions proposed by the plurality of sellers and select a seller that best matches the seller's preference. Hence, the buyer cannot achieve the conventional cost estimation method wherein the buyer selects the seller out of a plurality of sellers.

For example, suppose that a buyer wants to reserve a business hotel in Tokyo for the price of 10,000 yen. A seller A, among several other sellers, promptly sends a response to the service provider acting as an intermediary that the seller can reserve a room by 10,000 yen. The payment is made from the predetermined account of the buyer. After the notification by the seller A, a seller B notifies the service provider that the reservation for the buyer is possible with the price of 9,200 yen. Further, a response from a seller C follows which indicates that reservation in the amount of 9,000 yen is possible.

In this situation, however, the proposed condition by the seller A sent to the exchange provider matches the desired condition of the buyer and the payment is already made, i.e., transaction ends automatically. Thus, even when the subsequent offers by the seller B or seller C show better conditions, the buyer is unable to select the seller B or the seller C. In this regard, the “reverse auction method” described in the U.S. Pat. No. 5,794,207 fails to allow the buyer to control the transaction.

In general, the demand and price for services or goods often fluctuate by conditions such as a time, season, environmental situations and competition. For example, in using a hotel, the operation rate of the hotel is high in a sightseeing season or a long holiday season. Due to the balance between the supply and demand, hotels set the prices in such a season relatively high. On the other hand, in a slow season, the hotels tend to set lower prices. This is because, in the slow season, hotels prefer to fill the rooms with discounted prices rather than leaving the rooms empty. Thus, there is a possibility for negotiation in terms of price or other conditions by customers.

The reverse auction method described in the U.S. Pat. No. 5,794,207 does not allow such a room for negotiation. Thus, this method will not lead to price drop for goods and services, or fails to promote free competition for goods and services. Despite the availability of a seller that is willing to provide a price even lower than that of the buyer initially requested, such a situation or opportunity is ignored by this method.

In order to achieve the buyer driven transaction and to actualize price drop by inducing competition among the sellers, the inventors of the present invention have invented a new transaction apparatus and method which is described in Japanese Patent Application No. 2000-58769. The former invention relates to a transaction intermediary apparatus and method with a negotiation capability. The transaction intermediary apparatus can deal with the situation where a seller desires a transaction with a buyer with a price lower than the regular price. In this prior invention, the buyer can receive an offer from one or more sellers, and can select a seller which shows conditions best suited for the buyer.

The present invention is to further improve the transaction apparatus and method proposed in the prior invention. The conditions disclosed by the seller during the negotiation for the transaction of goods and services are, in principle, not intended to be open to public. The sellers do not want the conditions, such as discounted prices, sent to the buyer during the negotiation be easily known to third parties, especially competitors. Thus, for encouraging sellers to join the transaction system, or maintaining the membership of the sellers in the transaction system, it is preferable that discounted prices be disclosed only to the buyer who has requested the negotiation or shown the intention to enter into the transaction.

Further, it is preferable that a degree of negotiation can be changed according to specific situations of buyers. For example, businessmen may often prefer prompt transaction with a lesser degree of negotiation because they are busy. Buyers who have relatively more free time may prefer a higher degree of negotiation rather than a short time transaction. Playful buyers may prefer a wide range of negotiation. Thus, in order to accommodate buyers with varying levels of negotiation, it is preferable to provide multiple degrees of negotiation in the transaction apparatus.

In the transaction intermediary apparatus involving negotiation exchange, a seller may have a plurality of transaction sites in the system. In such a situation, the seller wants to send different data to different buyers, such as offers including prices and number of goods, etc., through the corresponding sites. For example, assume that a hotel A acting as a seller tries to input such data in three (3) transaction sites I-III for hotel room reservation. If the hotel A has 20 empty rooms, it may want to register twelve (12) rooms to a transaction site I which is the strongest in terms of attracting customers, five (5) rooms to transaction site II which is the second strongest, and three (3) rooms to transaction site III which has the least strength.

Further, a seller, such as a hotel having two or more transaction sites, has to respond to frequent negotiation requests transmitted though each site of the transaction intermediary system. Thus, the seller may have to employ an operator who exclusively deals with responses to the negotiation requests or a manager who has an authority to make decisions in the negotiation. Such an additional personnel or labor in the transaction increases the cost of goods and services provided by the seller.

In the transaction intermediary system, handling fees to be charged to sellers or buyers may differ from site to site or from sellers to sellers. Thus, for a seller who has two or more transaction sites or a transaction intermediary system that manages a large number of transaction sites, it is desirable to have a control center that manages all monetary exchange in all of the transactions.

### SUMMARY OF THE INVENTION

In view of the foregoing, it is an object of the present invention to provide a transaction intermediary apparatus, method and system with a negotiation capability in which a seller is able to provide discount price only to specified buyers to maintain confidentiality, thereby promoting membership of sellers in the transaction system.

It is another object of the present invention to provided a transaction intermediary apparatus and method with dynamic negotiation which is able to attract buyers of varying degrees of needs and conditions, thereby increasing the number of transactions and promoting sellers and buyers to use the transaction system.

It is a further object of the present invention to provided a transaction intermediary system with dynamic negotiation which is able to relieve the burdens of seller in managing and operating the transaction sites when seller has two or more transaction sites.

Reflecting upon the problems in the foregoing, the present invention aims to promote membership of sellers to the transaction system by increasing transactions of goods or services between sellers and buyers while maintaining the confidentiality of the discount price information by sending such information only to the specified buyers.

One aspect of the present invention is a transaction intermediary apparatus with a negotiation capability for trading goods or services between buyers and sellers for achieving buyer driven transactions including transactions resulted from negotiation requests initiated by buyers. The transaction intermediary apparatus includes a first offer data receiving means for receiving first offer data which includes price data of goods or services provided by at least one seller, a second offer data receiving means for receiving at least one kind of second offer data which has conditions more beneficial to buyers in price or quality than that of the first offer data, a requested condition data receiving means for receiving conditions requested by a buyer which includes at least a price range desired by the buyer for the goods or services, a data retrieving means for retrieving data concerning goods or services which matches the conditions requested by the buyer, a first offer means for offering the data on the goods or services retrieved from the first offer data by the data retrieving means to the buyer, a negotiation request receiving means for receiving at least one negotiation request which requests a transaction condition more beneficial to the buyer in the price or quality than the data retrieved from the first offer data, a second offer means for offering at least one kind of the second offer data to the buyer in response to the negotiation request, a transaction intent receiving means for receiving a transaction intent of the buyer to agree on the transaction after offering the second offer data at least once, and a transaction intent sending means for sending the transaction intent of the buyer to the seller which at least includes a seller who provides the goods or services agreed upon by the buyer. The second offer means adds a precise negotiation price, which has not been offered to the buyer, to the second offer data after the buyer sends the transaction intent to the seller.

According to the present invention, the negotiation price proposed by the seller is only visible to the buyer who requested the negotiation and shows his/her intention to complete the transaction. Therefore, for the buyer who merely accesses the transaction site or who concluded the transaction with the regular price without negotiation cannot see the exact amount of the negotiation price. Thus, the sellers can offer the negotiation price to an intended buyer at ease. In the foregoing, the condition more beneficial to the buyer does not always means less expensive goods or services. Some buyers may prefer less expensive price while some buyers may prefer transaction speed rather than price. Namely, the condition beneficial to the buyer means the condition more suited to the specific needs of the buyer.

Another aspect of the present invention is a transaction intermediary apparatus with a negotiation capability for trading goods or services between buyers and sellers for achieving buyer driven transactions including transactions resulted from negotiation requests initiated by buyers. The transaction intermediary apparatus includes a first offer data receiving means for receiving first offer data which includes price data of goods or services provided by at least one seller, a second offer data receiving means for receiving at least one kind of second offer data which has conditions more beneficial to buyers in price or quality than that of the first offer data, a requested condition data receiving means for receiving conditions requested by a buyer which includes at least a price range desired by the buyer for the goods or services, a data retrieving means for retrieving data concerning goods or services which matches the conditions requested by the buyer, a first offer means for offering the data on the goods or services retrieved from the first offer data by the data retrieving means to the buyer, a negotiation request receiving means for receiving at least one negotiation request which requests a transaction condition more beneficial to the buyer in the price or quality than the data retrieved from the first offer data, a second offer means for offering at least one kind of the second offer data to the buyer in response to the negotiation request, a transaction intent receiving means for receiving a transaction intent of the buyer to agree on the transaction after offering the second offer data at least once, a transaction intent sending means for sending the transaction intent of the buyer to the seller which at least includes a seller who provides the goods or services agreed upon by the buyer, and a confirmation display means for showing the buyer the confirmation display regarding the goods or services reaching the agreement, upon receiving the transaction intent. The confirmation display by the confirmation display means includes a negotiation price data which has not at all been offered or not been clearly offered to the buyer before the transaction intent is sent by the buyer.

According to the present invention, the buyer who requested the negotiation can be informed of only an approximate discount price and the buyer is informed of the exact amount of the discount price only at the completion of the transaction. Therefore, the exact discount price offered by the seller is not known by the buyer who ultimately selected another seller, thereby assuring confidentiality of the discount price.

Typically, the subject matter of the goods and services handled by the transaction intermediary apparatus of the present invention is hotel room reservation. In the present invention, during the negotiation process for making a hotel room reservation, the negotiation price is not known to competitors of the hotel or to buyers who do not make reservations. Here, the negotiation price is not only the negotiation price prepared by the hotel but also the price requested by the buyer. Thus, suppose a buyer desired a hotel room reservation with a price of 8,000 yen when he requested a negotiation, and the seller was ready to offer the room with a price of 7,000 yen, the hotel offers a negotiation price of 8,000 yen. The negotiation price of 8,000 yen is displayed at the conclusion of the transaction since this is the price requested by the buyer. This is favorable to the hotel since the final price is not bound by the negotiation price prepared by the hotel in advance.

A further aspect of the present invention is a transaction intermediary method involving a negotiation capability for trading goods or services between buyers and sellers for achieving buyer driven transactions including transactions resulted from negotiation requests initiated by buyers. The method includes the steps of a first offer data receiving step for receiving first offer data which includes price data of goods or services provided by at least one seller, a second offer data receiving step for receiving at least one kind of second offer data which has conditions more beneficial to buyers in price or quality than that of the first offer data, a requested condition data receiving step for receiving conditions requested by a buyer which includes at least a price range desired by the buyer for the goods or services, a data retrieving step for retrieving data concerning goods or services which matches the conditions requested by the buyer, a first offer step for offering the data on the goods or services retrieved from the first offer data through the data retrieving step to the buyer, a negotiation request receiving step for receiving at least one negotiation request which requests a transaction condition more beneficial to the buyer in the price or quality than the data retrieved from the first offer data, a second offer step for offering at least one kind of the second offer data to the buyer in response to the negotiation request, a transaction intent receiving step for receiving a transaction intent of the buyer to agree on the transaction after offering the second offer data at least once, and a transaction intent sending step for sending the transaction intent of the buyer to the seller which includes at least a seller who provides the goods or services agreed upon by the buyer. The second offer step adds a precise negotiation price, which has not been offered to the buyer, to the second offer data after the buyer sends the transaction intent to the seller.

According to the present invention, the negotiation price proposed by the seller is known only to the buyer who requested the negotiation and shows his/her intention to complete the transaction. Therefore, for the buyer who merely accesses the transaction site or who concluded the transaction with the regular price without negotiation or competitors of the seller cannot see the exact amount of the negotiation price. Thus, the sellers can offer the negotiation price to an intended buyer at ease.

A further aspect of the present invention is a transaction intermediary method involving a negotiation capability for trading goods or services between buyers and sellers for achieving buyer driven transactions including transactions resulted from negotiation requests initiated by buyers. The method includes the steps of a first offer data receiving step for receiving first offer data which includes price data of goods or services provided by at least one seller, a second offer data receiving step for receiving at least one kind of second offer data which has conditions more beneficial to buyers in price or quality than that of the first offer data, a requested condition data receiving step for receiving conditions requested by a buyer which includes at least a price range desired by the buyer for the goods or services, a data retrieving step for retrieving data concerning goods or services which matches the conditions requested by the buyer, a first offer step for offering the data on the goods or services retrieved from the first offer data by the data retrieving step to the buyer, a negotiation receiving step for receiving at least one negotiation request which requests a transaction condition more beneficial to the buyer in the price or quality than the data retrieved from the first offer data, a second offer step for offering at least one kind of the second offer data to the buyer in response to the negotiation request, a transaction intent receiving means for receiving a transaction intent of the buyer to agree on the transaction after offering the second offer data at least once, a transaction intent sending step for sending the transaction intent of the buyer to the seller which includes at least a seller who provides the goods or services agreed upon by the buyer, and a confirmation display step for showing the buyer the confirmation display regarding the goods or services that have reached the agreement, upon receiving the transaction intent. The confirmation display in the confirmation display step includes a negotiation price data which has not at all been offered or not been clearly offered to the buyer before the transaction intent is sent by the buyer.

According to the present invention, the buyer who requested the negotiation can be informed of only an approximate discount price and the buyer is informed of the exact amount of the discount price only at the completion of the transaction. Therefore, the exact discount price offered by the seller is not known by the buyer who ultimately selected another seller, thereby assuring confidentiality of the discount price.

In the foregoing, the subject matter of the goods and services handled by the transaction intermediary method of the present invention is hotel room reservation. In the present invention, during the negotiation process for making a hotel room reservation, the negotiation price is not known to competitors of the hotel or to buyers who do not make reservations.

A further aspect of the present invention is a transaction intermediary apparatus with a negotiation capability for trading goods or services between buyers and sellers for achieving buyer driven transactions including transactions resulted from negotiation requests initiated by buyers. The transaction intermediary apparatus includes a first offer data receiving means for receiving first offer data which includes price data of goods or services provided by at least one seller, a second offer data receiving means for receiving at least one kind of second offer data which has conditions more beneficial to buyers in price or quality than that of the first offer data, a requested condition data receiving means for receiving conditions requested by a buyer which includes at least a price range desired by the buyer for the goods or services, a data retrieving means for retrieving data concerning goods or services which matches the conditions requested by the buyer, a first offer means for offering the data on the goods or services retrieved from the first offer data by the data retrieving means to the buyer, a negotiation request receiving means for receiving at least one negotiation request which requests a transaction condition more beneficial to the buyer in the price or quality than the data retrieved from the first offer data, a negotiator character display means for displaying a plurality of negotiator characters each having a different negotiation capability from one another upon receiving the negotiation request, a negotiator character selection receiving means for receiving a selected negotiator character from the buyer, a negotiation action display means for displaying actions of the selected negotiator character on a terminal screen of the buyer, a second offer means for offering at least one kind of the second offer data to the buyer after the actions of the selected negotiator character, a transaction intent receiving means for receiving a transaction intent of the buyer to agree on the transaction after offering the second offer data at least once, and a transaction intent sending means for sending the transaction intent of the buyer to the seller which at least includes a seller who provides the goods or services agreed upon by the buyer.

According to the present invention, the buyer can negotiate with the seller with negotiation conditions freely selected by the buyer. Therefore, the transaction intermediary apparatus is capable of satisfying buyers of variety of purchase conditions and desires. Further, since the images of different negotiation characters are displayed on the buyer terminals, it is also possible for buyers to enjoy games while negotiating with sellers.

A further aspect of the present invention is a transaction intermediary apparatus with a negotiation capability for trading goods or services between buyers and sellers for achieving buyer driven transactions including transactions resulted from negotiation requests initiated by buyers. The transaction intermediary apparatus includes a first offer data receiving means for receiving first offer data which includes price data of goods or services provided by at least one seller, a second offer data receiving means for receiving at least one kind of second offer data which has conditions more beneficial to buyers in price or quality than that of the first offer data, a requested condition data receiving means for receiving conditions requested by a buyer which includes at least a price range desired by the buyer for the goods or services, a data retrieving means for retrieving data concerning goods or services which matches the conditions requested by the buyer, a first offer means for offering the data on the goods or services retrieved from the first offer data by the data retrieving means to the buyer, a negotiation request receiving means for receiving at least one negotiation request which requests a transaction condition more beneficial to the buyer in the price or quality than the data retrieved from the first offer data, a negotiator character display means for, upon receiving the negotiation request, displaying a plurality of negotiator characters from a novice negotiation character having the lowest negotiation capability to a hard negotiator character having the highest negotiation capability in this order depending on a number of times of the negotiation request, a negotiation action display means for displaying actions of the negotiator character on a terminal screen of the buyer, a second offer means for offering at least one kind of the second offer data to the buyer after the actions of the negotiator character, a transaction intent receiving means for receiving a transaction intent of the buyer to agree on the transaction after offering the second offer data at least once, and a transaction intent sending means for sending the transaction intent of the buyer to the seller which at least includes a seller who provides the goods or services agreed upon by the buyer.

In the above inventions involving the different levels of negotiation character, preferably, a waiting time required before offering the second offer data is proportional to a degree of negotiation capability of the negotiator character in that the higher the negotiation capability, the longer it becomes the waiting time. Accordingly, for a buyer who wants the negotiation time as short as possible, the intermediary apparatus can provide a negotiation result in a short time while the negotiation rate will be small. Conversely for a buyer who wants the negotiation rate as high as possible, the intermediary apparatus can provide the negotiation result with a higher negotiation rate while it takes a longer time before sending the negotiation result. Thus, buyers can take the relationship between the time length and the negotiation rate into consideration when requesting a negotiation.

In the above inventions involving the different levels of negotiation character, preferably, the second offer means sends a predetermined negotiation price to the buyer when the negotiation character display means displays the novice negotiation character, and the transaction intermediary apparatus further includes a negotiation request transmission means to send the negotiation request to the seller when the negotiation character display means displays the hard negotiator character, and the second offer means offers the second offer data received from the seller in response to the negotiation request to the buyer.

Accordingly, when a negotiation rate requested in the negotiation from the buyer is low, the intermediary apparatus can offer the negotiation price already stored in the intermediary apparatus, thereby being able to quickly respond to the buyer's request. In contrast, when the negotiation rate requested by the buyer is high, the intermediary apparatus waits for the seller's response, thereby taking a longer time to respond to the buyer.

In the above inventions involving the different levels of negotiation character, preferably, the negotiation character display means displays a gambler negotiator character in response to the selection by the buyer where the gamble negotiator character determines a degree of negotiation through a gamble, and the second offer means offers the degree of negotiation to the buyer where the degree of negotiation is determined by a random number or a score of a game generated by a program prepared in advance.

By this arrangement, a buyer who likes a gamble can enjoy the transaction. Especially, the negotiation result through the gambler negotiator includes a price which extends from almost free to as much as a listed price. Thus, the buyer can enjoy a gamble game through the intermediary apparatus of the present invention.

In the foregoing, the subject matter of the goods and services handled by the transaction intermediary apparatus of the present invention is hotel room reservation. Because of the different levels of negotiation capability, the transaction intermediary apparatus is capable of satisfying buyers of variety of purchase conditions and desires.

A further aspect of the present invention is transaction intermediary method involving a negotiation capability for trading goods or services between buyers and sellers for achieving buyer driven transactions including transactions resulted from negotiation requests initiated by buyers. The transaction intermediary method includes the steps of a first offer data receiving step for receiving first offer data which includes price data of goods or services provided by at least one seller, a second offer data receiving step for receiving at least one kind of second offer data which has conditions more beneficial to buyers in price or quality than that of the first offer data, a requested condition data receiving step for receiving conditions requested by a buyer which includes at least a price range desired by the buyer for the goods or services, a data retrieving step for retrieving data concerning goods or services which matches the conditions requested by the buyer, a first offer step for offering the data on the goods or services retrieved from the first offer data by the data retrieving step to the buyer, a negotiation request receiving step for receiving at least one negotiation request which requests a transaction condition more beneficial to the buyer in the price or quality than the data retrieved from the first offer data, a negotiator character display step for displaying a plurality of negotiator characters each having a different negotiation capability from one another upon receiving the negotiation request, a negotiator character selection receiving step for receiving a selected negotiator character from the buyer, a negotiation action display step for displaying actions of the selected negotiator character on a terminal screen of the buyer, a second offer step for offering at least one kind of the second offer data to the buyer after the actions of the selected negotiator character, a transaction intent receiving step for receiving a transaction intent of the buyer to agree on the transaction after offering the second offer data at least once, and a transaction intent sending step for sending the transaction intent of the buyer to the seller which at least includes a seller who provides the goods or services agreed upon by the buyer.

According to the present invention, the buyer can negotiate with the seller with a negotiation condition freely selected by the buyer. Therefore, the transaction intermediary apparatus is capable of satisfying buyers of variety of purchase conditions and desires. Further, since the images of different negotiation characters are displayed on the buyer terminals, it is also possible for buyers to enjoy games while negotiating with sellers.

A further aspect of the present invention is a transaction intermediary method involving a negotiation capability for trading goods or services between buyers and sellers for achieving buyer driven transactions including transactions resulted from negotiation requests initiated by buyers. The transaction intermediary method includes the steps of a first offer data receiving step for receiving first offer data which includes price data of goods or services provided by at least one seller, a second offer data receiving step for receiving at least one kind of second offer data which has conditions more beneficial to buyers in price or quality than that of the first offer data, a requested condition data receiving step for receiving conditions requested by a buyer which includes at least a price range desired by the buyer for the goods or services, a data retrieving step for retrieving data concerning goods or services which matches the conditions requested by the buyer, a first offer step for offering the data on the goods or services retrieved from the first offer data by the data retrieving step to the buyer, a negotiation request receiving step for receiving at least one negotiation request which requests a transaction condition more beneficial to the buyer in the price or quality than the data retrieved from the first offer data, a negotiator character display step for, upon receiving the negotiation request, displaying a plurality of negotiator characters from a novice negotiation character having the lowest negotiation capability to a hard negotiator character having the highest negotiation capability in this order depending on a number of times of the negotiation request, a negotiation action display step for displaying actions of the negotiator character on a terminal screen of the buyer, a second offer step for offering at least one kind of the second offer data to the buyer after the actions of the negotiator character, a transaction intent receiving step for receiving a transaction intent of the buyer to agree on the transaction after offering the second offer data at least once, and a transaction intent sending step for sending the transaction intent of the buyer to the seller which at least includes a seller who provides the goods or services agreed upon by the buyer.

In the above inventions involving the different levels of negotiation character, preferably, a waiting time required before offering the second offer data is proportional to a degree of the negotiation capability of the negotiator character in that the higher the negotiation capability, the longer it becomes the waiting time. Accordingly, for a buyer who wants the negotiation time as short as possible, the intermediary apparatus can provide a negotiation result in a short time while the negotiation rate will be small. Conversely for a buyer who wants the negotiation rate as high as possible, the intermediary apparatus can provide the negotiation result with a higher negotiation rate while it takes a longer time before sending the negotiation result. Thus, buyers can take the relationship between the time length and the negotiation rate into consideration when requesting a negotiation.

In the above inventions involving the different levels of negotiation character, preferably, the second offer step sends a predetermined negotiation price to the buyer when the negotiation character display step displays the novice negotiation character, and the transaction intermediary method further includes a negotiation request transmission step to send the negotiation request to the seller when the negotiation character display step displays the hard negotiator character, and the second offer step offers the second offer data received from the seller in response to the negotiation request to the buyer.

Accordingly, when a negotiation rate requested in the negotiation from the buyer is low, the intermediary method can offer the negotiation price already stored in the intermediary apparatus, thereby being able to quickly respond to the buyer. In contrast, when the negotiation rate requested by the buyer is high, the intermediary method waits for the seller's response, thereby taking a longer time to respond to the buyer.

In the above inventions involving the different levels of negotiation character, preferably, the negotiation character display step displays a gambler negotiator character in response to the selection by the buyer where the gamble negotiator character determines a degree of negotiation through a gamble, and the second offer step offers the degree of negotiation to the buyer where the degree of negotiation is determined by a random number or a score of a game generated by a program prepared in advance.

By this arrangement, a buyer who likes a gamble can enjoy the transaction. Especially, the negotiation result through the gambler negotiator includes a price which extends from almost free to as much as a listed price. Thus, the buyer can enjoy a gamble game through the intermediary apparatus of the present invention.

In the foregoing, the subject matter of the goods and services handled by the transaction intermediary method of the present invention is hotel room reservation. Because of the different levels of negotiation capability, the transaction intermediary method is capable of satisfying buyers of variety of purchase conditions and desires.

A further aspect of the present invention is a transaction intermediary system with a negotiation capability for trading goods or services between buyers and sellers for achieving buyer driven transactions including transactions resulted from negotiation requests initiated by buyers. The intermediary transaction system includes, a plurality of seller data terminals for inputting and outputting data by sellers who want to sell goods or services, a plurality of buyer data terminals for inputting and outputting data by buyers who want to buy goods or services, a plurality of transaction intermediary apparatuses provided between the seller data terminals and the buyer data terminals for assisting trade of goods or services between buyers and sellers including negotiation therebetween, and a data center provided between the transaction intermediary apparatuses and the seller data terminals for distributing data input through the seller data terminals to a plurality of transaction sites operated by the transaction intermediary apparatuses.

In the above system, the data center operates the steps of receiving summary data which summarizes first offer data which includes price data of goods or services provided by at least one seller which is installed in the plurality of transaction sites, distributing the summary data based on distribution ratios predetermined or transmitted from the sellers and sending the distributed first offer data to the transaction sites, receiving second summary data which summarizes at least one kind of second offer data which has conditions more beneficial to buyers in price or quality than that of the first offer data, and distributing the second summary data based on distribution ratios predetermined or transmitted from the sellers and sending the distributed second offer data to the transaction sites.

In the above system, each of the transaction intermediary apparatuses operates the steps of receiving conditions requested by a buyer which includes at least a price range desired by the buyer for the goods or services, retrieving data concerning goods or services which matches the conditions requested by the buyer, offering the data on the goods or services retrieved from the first offer data by the data retrieving step to the buyer, receiving at least one negotiation request which requests a transaction condition more beneficial to the buyer in the price or quality than the data retrieved from the first offer data, offering at least one kind of the second offer data to the buyer in response to the negotiation request, receiving a transaction intent of the buyer to agree on the transaction after offering the second offer data at least once, and sending the transaction intent of the buyer to the sellers which at least includes a seller who provides the goods or services agreed upon by the buyer.

According to the present invention, the sellers need not send information regarding goods or services to the plurality of transaction sites. The sellers can send only the summary data which summarizes first offer data and the summary data which summarizes second offer data to the data center. The distribution of the offer data to each of the transaction sites is done by the data center. Thus, the sellers burdens are substantially relieved, thereby achieving reduction of cost for the goods or services.

A further aspect of the present invention is a transaction intermediary system with a negotiation capability for trading goods or services between buyers and sellers for achieving buyer driven transactions including transactions resulted from negotiation requests initiated by buyers. The transaction intermediary system includes a plurality of seller data terminals for inputting and outputting data by sellers who want to sell goods or services, a plurality of buyer data terminals for inputting and outputting data by buyers who want to buy goods or services, a plurality of transaction intermediary apparatuses provided between the seller data terminals and the buyer data terminals for assisting trade of goods or services between buyers and sellers including negotiation therebetween, and a data center provided between the transaction intermediary apparatuses and the seller data terminals for sending, on behalf of the sellers, completion of transaction to transaction sites operated by the transaction intermediary apparatuses.

In this system, the data center operates the steps of receiving first offer data which includes price data of goods or services provided by at least one seller and second offer data which has conditions more beneficial to buyers in price or quality than that of the first offer data, and sending the first offer data and the second offer data to transaction intermediary apparatuses. Each of the transaction intermediary apparatuses operates the steps of receiving conditions requested by a buyer which includes at least a price range desired by the buyer for the goods or services, retrieving data concerning goods or services which matches the conditions requested by the buyer, offering the data on the goods or services retrieved from the first offer data by the data retrieving step to the buyer, receiving at least one negotiation request which requests a transaction condition more beneficial to the buyer in the price or quality than the first offer data, sending at least one negotiation request by the buyer to the data center, receiving the second offer data from the data center at least once, and receiving a transaction intent of the buyer to agree on the transaction and sending the transaction intent of the buyer to the data center. The data center transmits the transaction intent received by the transaction intermediary apparatuses to the seller data terminals.

According to the present invention, the sellers need not offer the regular price or the negotiation price to buyers but the data center do this processes on behalf of the sellers. Thus, when the transaction is completed, only the final result is reported to the seller. Accordingly, by standardizing the responses to the negotiation requests, the data center can perform almost all of the jobs necessary in the transaction for the plurality of sellers, thereby relieving burdens of sellers in the transaction.

A further aspect of the present invention is a transaction intermediary system with a negotiation capability for trading goods or services between buyers and sellers for achieving buyer driven transactions including transactions resulted from negotiation requests initiated by buyers. The transaction intermediary system includes a plurality of seller data terminals for inputting and outputting data by sellers who want to sell goods or services, a plurality of buyer data terminals for inputting and outputting data by buyers who want to buy goods or services, a plurality of transaction intermediary apparatuses provided between the seller data terminals and the buyer data terminals for assisting trade of goods or services between buyers and sellers including negotiation therebetween, and a data center provided between the transaction intermediary apparatuses and the seller data terminals for collecting, on behalf of the transaction sites operated by the transaction intermediary apparatuses, necessary fees for transaction from buyers.

In this system, each of the transaction intermediary apparatuses operates the steps of receiving first offer data which includes price data of goods or services provided by at least one seller and second offer data which has conditions more beneficial to buyers in price or quality than that of the first offer data, sending the first offer data and the second offer data to the buyer data terminals, receiving conditions requested by a buyer which includes at least a price range desired by the buyer for the goods or services, retrieving data concerning goods or services which matches the conditions requested by the buyer, offering the data on the goods or services retrieved from the first offer data by the data retrieving step to the buyer, receiving at least one negotiation request which requests a transaction condition more beneficial to the buyer in the price or quality than the first offer data, and at the same time, receiving credit account data of the buyer, sending at least one negotiation request by the buyer to the seller data terminals, receiving the second offer data from the seller data terminals at least once, and receiving a transaction intent of the buyer to agree on the transaction and sending the transaction intent of the buyer to the seller data terminal. The data center receives the credit account data of the buyer and collects at least one of negotiation request bond involved in receiving the negotiation request, option fees involved in reserving the transaction of goods or services, and transaction fee involved in completing the transaction, from at least one of the buyer and seller.

According to the present invention, a manager of each transaction site of each seller needs not to collect the fees from the buyers, and similarly, the manager of each transaction site needs not to collect the fees from the sellers, because the data center performs the fee collection works. For example, when the fees are different from site to site or seller to seller, the fee collection procedures would be very complicated unless done by the data center. Since the data center performs these collection works on behalf of the sellers and transaction sites, the sellers and transaction sites can receive the fees without fail.

### BRIEF DESCRIPTION OF THE DRAWINGS

FIG. 1 is a block diagram showing an example of network system including the transaction intermediary apparatus of the present invention having a negotiation capability.

FIG. 2 is a block diagram showing an example of structure in the transaction intermediary apparatus of the present invention.

FIG. 3 is a chart showing example of types of negotiator, degrees of negotiation, response times, and fees charged to buyers in the transaction intermediary apparatus of the present invention.

FIG. 4 is a chart showing example of price ranges including regular price and discount prices upon degrees of negotiation, discount rates, and fees charged to buyers and sellers in the transaction intermediary apparatus of the present invention.

FIGS. 5A-5C are diagrams showing an example of images displayed on the buyer terminal during the transaction process based on the data from the transaction intermediary apparatus of the present invention.

FIGS. 6A and 6B are diagrams showing an example of images displayed on the buyer terminal during the transaction process when the buyer selects a novice negotiator character following the images of FIGS. 5A-5C.

FIGS. 7A and 7B are diagrams showing an example of images displayed on the buyer terminal during the transaction process when the buyer selects a hard negotiator character following the images of FIGS. 5A-5C.

FIGS. 8A and 8B are diagrams showing an example of images displayed on the buyer terminal during the transaction process when the buyer selects a gambler negotiator character following the images of FIGS. 5A-5C.

FIGS. 9A and 9B are diagrams showing an example of images displayed on the buyer terminal during the transaction process after the step of either FIGS. 6, 7 or 8 starting from displaying the selected hotel and ending by completing the reservation procedure.

FIG. 10 is a flow chart showing the operational process in the transaction intermediary apparatus of the present invention involving dynamic negotiation.

FIG. 11 is a flow chart showing the operational process following the process of FIG. 10 in the transaction intermediary system of the present invention involving dynamic negotiation.

FIG. 12 is a flow chart showing the operational process following the process of FIG. 11 in the transaction intermediary apparatus of the present invention involving dynamic negotiation.

FIG. 13 is a block diagram showing an example of transaction intermediary system with dynamic negotiation of the present invention which includes a plurality of transaction intermediary apparatuses each having a transaction site, and a data center connected to the intermediary apparatuses.

FIG. 14 is a block diagram showing an example of structure in the data center in the transaction intermediary system of the present invention.

### DETAILED DESCRIPTION OF THE PREFERRED EMBODIMENTS

The embodiments of the transaction intermediary apparatus, method and system of the present invention will be described hereafter with reference to the accompanying drawings. Hereafter, the present invention is described for the case in which the subject matter of the transaction is hotel reservation only for an illustration purpose. Thus, the present invention is not limited to that particular application, but it can be applicable to any other services or goods.

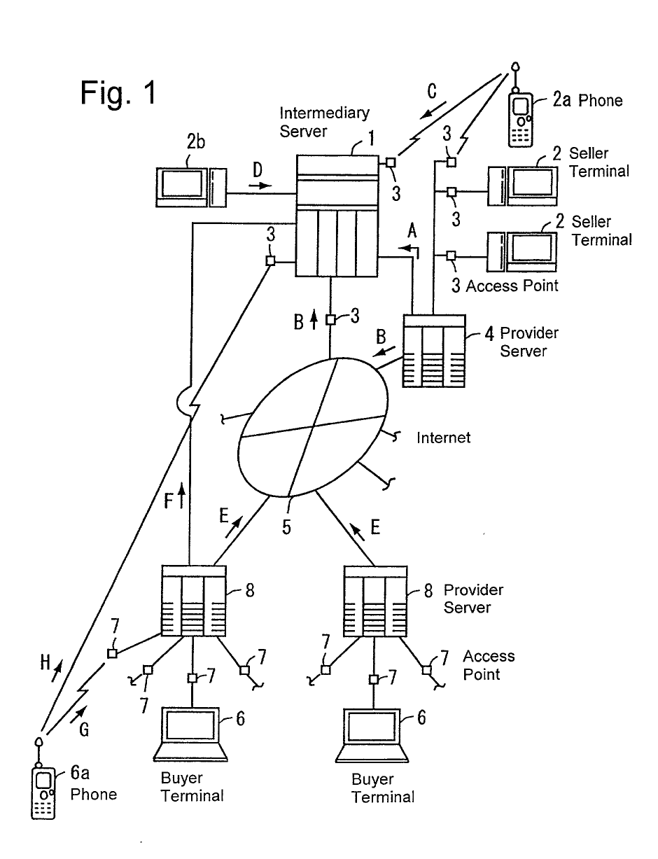

FIG. 1 shows an example of network system including the transaction intermediary apparatus of the present invention having a negotiation function. The transaction intermediary apparatus 1 (Hereafter “intermediary server 1”) is a computer system that receives various kinds of data from sellers and sends the seller's offer data to buyers through the communication network in response to the requests made by the buyers. The sellers send the offer data through seller data terminals 2 or wireless telephones (cellular phones) 2a. The buyers send the initial request or negotiation request from buyer terminals 6 or wireless telephones (cellular phone) 6a. FIG. 1 also shows a communication network such as Internet 5 and Internet provider servers 4 and 8. Numerals 3 and 7 denote access points in the communication network.

The intermediary server 1 receives first offer data from the seller data terminal 2 (hereafter may also be referred to as “hotel terminal 2”) which is directed to hotel room information for hotel room reservation purposes. The first offer data includes information on regular prices of the rooms, grades of the rooms, and types (single or twin, etc) of the rooms. The intermediary server 1 also receives second offer data from the hotel terminal 2 produced by the seller in response to the terms and conditions in the negotiation requested by the buyer.

In this example, the second offer data includes hotel room information which is more favorable to the buyer, for example, a price (“negotiation price” or “nego-price”) of the room which is less expensive than that shown in the first offer data. Therefore, the hotel can send not only the first offer data establishing a regular price, but also the second offer data with a negotiation price to the intermediary server 1. However, the hotels (sellers) do not have to negotiate on all of the terms and conditions in the first offer data. Depending on the type of the room, the grade of the room, etc., the seller only needs to send second offer data for the terms and conditions that can be negotiated based on seller's judgement.

The hotel room information from the hotel terminals 2 is sent to the provider servers 4 established by the Internet provider through the access points 3. Then, the hotel room information is directly sent to the intermediary server 1 (arrow A) from the provider server 4. The hotel room information can also be sent from the provider server 4 to the intermediary server 1 thorough the Internet 5 (arrow B).

As noted above, the seller data terminal 2 may be the wireless (cellular) phone 2a in addition to the hotel terminal 2. In such a case, the hotel room information is sent to the provider server 4 from the cellular phone 2a through the access point 3. The information transmitted from the cellular phone 2a to the provider server 4 can be transmitted either directly to the intermediary server 1 (arrow A) or though the Internet (arrow B). Moreover, the hotel room information can be directly transmitted to the intermediary server 1 (arrow C) without passing through the provider server 4. Accordingly, a person of a hotel in charge of this transaction apparatus can input and transmit the hotel room information while being away from his/her office. The seller data terminal 2 can be a dedicated terminal 2s that is connected to a dedicated line to the intermediary server 1. In such an arrangement, the hotel room information is transmitted to the intermediary server 1 (arrow D) without going through other facilities such as the provider server 4.

A customer (buyer) inputs data including desired conditions for hotel room reservation from the customer data terminal 6 (hereafter may also be referred to as “customer terminal 6”). More particularly, the customer's data regarding the purchase conditions (“customer purchase condition”) may include a location of hotel, a type of room and a price. The customer purchase condition is then transmitted to each provider server 8 through the access point 7. The customer purchase condition is sent to the intermediary server 1 through the Internet 5 (arrow E). The customer purchase condition can be transmitted directly to the intermediary server 1 from the provider server 8 without passing through the Internet 5 (arrow F).

The customer terminal 6 may be the wireless (cellular) phone 6a in addition to the customer terminal. In such a case, the customer purchase condition is sent to the provider server 8 from the cellular phone 6a through the access point 7. The data transmitted from the cellular phone 6a to the provider server 8 can be transmitted either directly to the intermediary server 1 (arrow F) or though the Internet (arrow E). Moreover, the customer purchase condition can be directly transmitted to the intermediary server 1 (arrow H) without involving the provider server 8. Accordingly, the customer (buyer) of this transaction system can input and transmit the purchase conditions while being away from his/her home or office.

As described in the foregoing, the hotel and the customer can transmit data to the intermediary server 1 or receive the other party's data through several routes. When such transmission is made through the Internet 5, the customer can make reservation for a hotel room by connecting his/her computer to the Internet 5. The hotel can offer or accept reservation order by connecting its computer to the Internet 5. Thus, the transaction intermediary system of the present invention is preferably implemented with the Internet for creating an easy and convenient system.

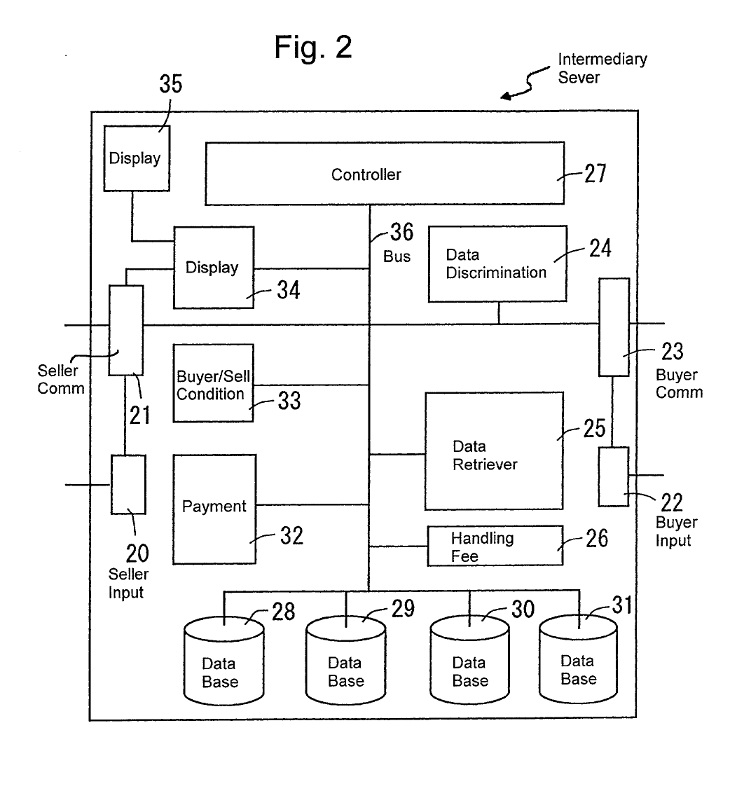

An example of configuration in the intermediary server 1 of the present invention is shown in the block diagram of FIG. 2. The intermediary server 1 includes a seller input area 20, a seller communication section 21, a buyer input area 22, a buyer communication section 23, a data discriminator 24, a data retriever 25, an intermediary handling fee unit 26, a control unit 27, a regular price database 28, and negotiation price database 29, 30 and 31, a payment processing unit 32, a buy/sell condition processor 33, a display processor 34, a display 35, and a bus 36.

The seller input area 20 is an area which receives the hotel room information from the hotel (seller). The seller input area 20 stores the hotel information which is input in the intermediary server 1 by a responsible hotel personnel or a sever manager who is instructed by the hotel employee over a telephone or facsimile. The seller communication section 21 receives data from the seller through the communication network. The seller communication section 21 functions as a first offer data receiving means and a second offer data receiving means for receiving offer data from the hotel as well as a negotiation condition transmission means for sending the negotiation terms to the hotel. The data received by the seller input area 20 is also transmitted to the seller communication section 21.

The buyer input area 22 is an area which receives the customer purchase condition data (requested hotel reservation condition) from the buyer. The buyer input area 22 stores the requested hotel reservation condition directly input in the intermediary server 1 by the buyer or a sever manager who is instructed by the buyer over a telephone or facsimile. The buyer communication section 23 receives the data from the buyer through the communication network. The buyer communication section 23 functions as a purchase condition receiving means, a negotiation request receiving means, a transaction intent receiving means, and a negotiator character selection means when receiving data from the buyer. The data received by the buyer input area 22 is also transmitted to the buyer communication section 23.

The data discriminator 24 determines whether the input data from the customer concerns either the desired purchase condition, a negotiation request, an intention to complete the transaction, or the end of the transaction. The data discriminator 24 performs this determination function under the control of the controller 27 which will be described later. The data retriever 25, after receiving the desired purchase condition data from the customer, checks the first offer data given by the hotel in the regular price database 28 to see if there is data that matches the requested purchase condition. If necessary, the data retriever 25 also checks the second offer data in the negotiation price database 29, 30 or 31 to see if there is data that matches the purchase conditions requested in the negotiation from the customer, the details of which will be described later.

The intermediary handling fee unit 26 is to set handling fees to be charged to the hotel (seller) and the customer (buyer) depending on the contents of transaction. More particularly, different intermediary handling fees will be established when the hotel reservation is completed, for example, whether in the regular price or in the negotiated price. In addition, in the negotiation price, the amount of handling fees may vary based on the level of negotiation or negotiator's character, the details of which will be explained later.

The controller 27 controls an overall operational procedure of the intermediary server 1. The controller 27 also works as a negotiation displaying and processing means that controls and displays the activities of the different characters of negotiator as described later.

The regular price database 28 stores the hotel room information including the regular price that is pre-registered by the hotel. More specifically, the data in the database 28 shows information such as grades of the rooms, types of the rooms, visual images of the rooms, the prices of the rooms, various facilities (restaurants, clubs, shops, exercise room, etc.) in the hotel and associated charges.

The negotiation price database 29 stores the hotel room information including the negotiation price with a first predetermined negotiation rate that is pre-transmitted by the hotel. The negotiation price database 30 stores the hotel room information including the negotiation price with a second negotiation rate that is predetermined by the hotel. The second negotiation rate or discount rate is higher than the first negotiation rate. Similarly, the negotiation price database 31 stores the hotel room information including the negotiation price with a third negotiation rate that is predetermined by the hotel. The third negotiation rate or discount rate has a very wide range such as from 0-100% depending on other parameters associated with the hotel room reservation.

The negotiation price database 31 has a random number generator (not shown). When the database 31 is used, a negotiation rate is determined based on the random number generated by the random number generator. The negotiation price corresponding to the rate thus determined is output from the negotiation price database 31.

The information on the same room in the same hotel may be stored in the database 28, 29, 30, and 31. However, the contents of the information, typically, their prices vary among the database. Moreover, hotel room data of almost identical price is also stored in each database 28, 29, 30, 31. For example, in the regular price database 28, a single room with the price of 10,000 yen per night may be stored, while in the negotiation price database 29, a deluxe room with the price of 10,000 yen per night may be stored.

The payment processing unit 32 performs a payment procedure such as by a credit card. It also includes a payment procedure to pay a fee to the manager of the intermediary server 1 by the customer or the hotel for intermediary handling charge when such a manager assists the transaction. The payment processing unit 32 performs the payment procedure based on the customer and hotel information such as the credit card numbers.

The buy/sell condition processor 33 functions as a first offer data providing means or a second offer data providing means which converts the data searched by the data retriever 25 into a predetermined format and provides the offer data to the customer. The buy/sell condition processor 33 adds information whether negotiation is possible to the hotel room information that matches the customer purchase condition data, or arranges the hotel room information that matches the negotiation request in the order of the price or the place of lodging. When providing the offer data, the buy/sell condition processor 33 can also add a display pointer in the offer data for enabling the customer to select whether other rooms in the same hotel or the rooms with the identical grade in other hotels should be searched.

The buy/sell condition processor 33 also functions as a transaction intent transmission means that transmits the intention of the customer (buyer) to complete the transaction to the hotel (seller). Further, the buy/sell condition processor 33 transmits the customer information such as the credit card number upon receiving the intention to complete the transaction by the customer.

The display processor 34 functions as a negotiator character displaying and processing means that displays a negotiator character on the customer terminal 6. Thus, the display processor 34 performs as a graphic display processor for producing animations of the negotiator characters. As noted above, a plurality of different levels of negotiators are available in the transaction intermediary system of the present invention. The display processor 34 also functions as a transaction confirmation displaying and processing means that displays the contents of the transaction, i.e., the details of the hotel room reservation in the above example, to the customer upon receiving the customers intention to complete the transaction.

The display 35 is a monitor having, for example, a liquid crystal display (LCD) or a cathode ray tube (CRT). Normally, the negotiator character is displayed on the customer terminal 6 which is remote from the intermediary server 1. However, there may be a case where the customer comes to an office where the intermediary server 1 locates to make a hotel room reservation. Hence, a monitor for such a customer is also provided to the intermediary server 1 so that the customer can enjoy the activities of the negotiator character. The bus 36 is an interface bus and circuit to connect each components in the intermediary server 1. Thus, in the intermediary server 1, the data and control and processing signals are communicated through the bus 36.

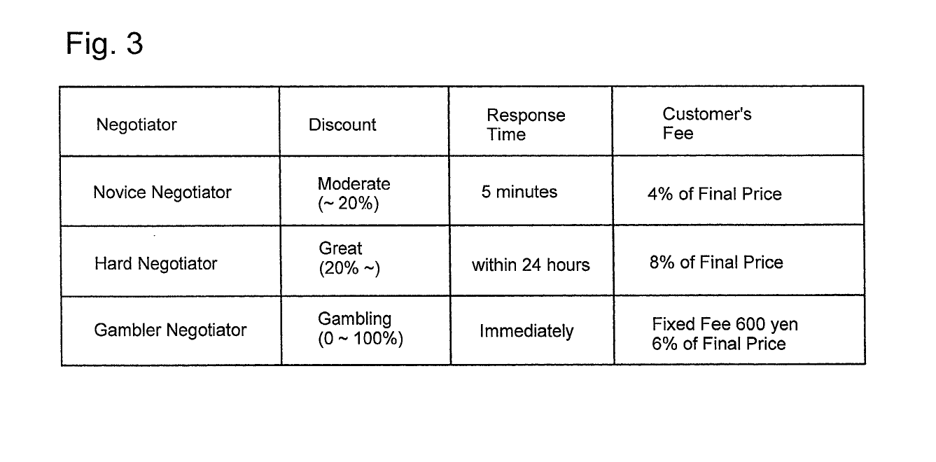

FIG. 3 is a table showing types of negotiator, degree of negotiation, response time, and fees to be charged to the customer in the transaction intermediary apparatus of the present invention. In this example, three kinds of negotiator character are provided with respect to the other parameters. These characters are a novice negotiator, a hard negotiator, and a gambler negotiator.

In the negotiation by the novice negotiator, the discount rate (negotiation rate) is less than 20%. In the negotiation by the hard negotiator, the discount rate is greater than 20%. The negotiation rates can also be altered by other factors such as season. In the negotiation by the gambler negotiator, the negotiation rate may vary from 0% to 100%. More particularly, the negotiation rate is determined by random numbers or games such as roulette.

The response time for the negotiation request differs depending on the types of negotiator characters. Here, the response time is a time between receiving a negotiation request from the customer and sending a negotiation (discount) price to the customer. In this example, for the novice negotiator, the response time is set to five (5) minutes. In the negotiation by the novice negotiator, the response time can be less than five (5) minutes since it only needs to send the predetermined negotiation price. However, in order to recreate the reality of negotiation, the response time is preferably set to longer than an actual data retrieval time.

In the case of the hard negotiator, the response time is set to less than 24 hours. In the negotiation by the hard negotiator, the intermediary server 1 sends the negotiation request to the hotel and waits for the response from the hotel. Thus, compared to the procedure by the novice negotiator, a relatively longer time is set to the negotiation before receiving the response from the hotel. However, it is possible to store the predetermined responses by the hotel in the intermediary server 1 for the negotiation request by the hard negotiator. In such a case, the response time for the hard negotiator can be substantially short similar to the novice negotiator.

In this manner, the negotiation rate and the response time vary depending on the types of negotiator. Thus, the customer may select the novice negotiator in a case where a short response time is desired. Alternatively, the customer can select the hard negotiator in a case where a higher negotiation rate is desired. Hence, the intermediary server 1 can accommodate these different levels of customer needs.

For the gambler negotiator, the response time is almost non-existent. More particularly, in the gamble negotiation, an image of playing a gamble game is shown on the buyer terminal 6. When the result of the gamble game is attained, the display shows the negotiation rate based on the result. In the gamble negotiation, only the data such as the negotiation price is retrieved from the negotiation price database 31, and there is no need to wait for the response from the hotel. Thus, unlike the novice negotiator, it is not required to consider the time required for negotiation with the hotel. Thus, the negotiation price is determined instantly based on the result of the gamble game without setting a response time of five minutes or the like after the negotiation request.

In this example of FIG. 3, the customer fee for the novice negotiator is 4% of the final price (final transaction price). In the negotiation by the hard negotiator, the customer fee is 8% of the final price. In the negotiation by the gambler negotiator, the customer fee is 6% of the final price. However, unlike other negotiations, in the gamble negotiation, the customer must pay a participation fee of, for example, 600 yen to enjoy the gamble game.

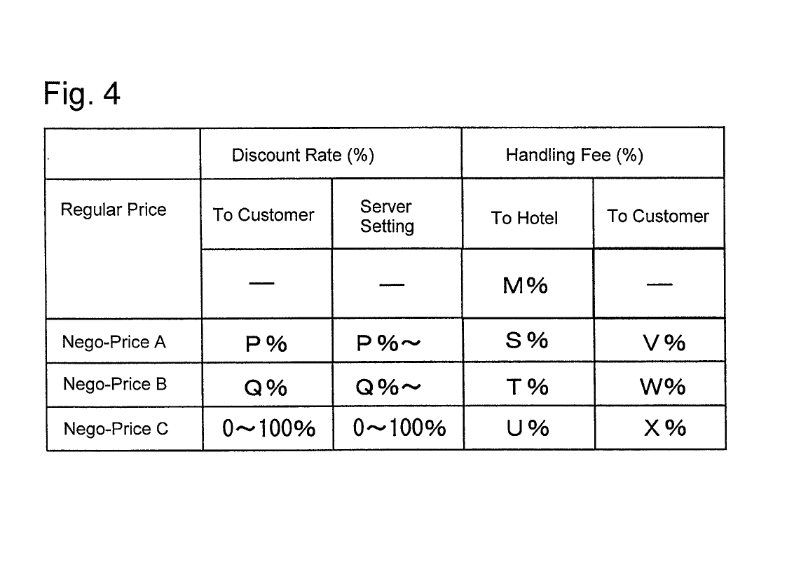

FIG. 4 is a table showing discount rate (%) relative to the regular price and negotiation price and the system handling fee (%) to the customer (buyer) and the hotel (seller). In this example, the negotiation price is classified into three (3) ranges A-C. The negotiation price (Nego-Price) A is the price assigned to the novice negotiator. The negotiation price (Nego-Price) B is the price assigned to the hard negotiator. The negotiation price (Nego-Price) C is for the gambler negotiator. There is no discount for the regular price. Thus, when the transaction is completed for the regular price, the intermediary server 1 receives only the handling fee from the hotel (M% of the regular price).

When the transaction is completed with the negotiation price A, the final price becomes P% less than the regular price. In order to guarantee the discount rate P% for the customer, the discount rate of more than P% can be established based on several conditions. In the negotiation completed through the novice negotiator, the intermediary handling fee to the hotel is S% of the negotiation price A while the intermediary handling fee to the customer is V% of the negotiation price A.

The negotiation price B for the hard negotiator has a higher negotiation rate than that of the negotiation price A. The negotiation price B is the final price which is lower than the regular price by the discount rate Q%. In order to guarantee the discount rate Q% for the customer, the discount rate more than Q% can be established based on several conditions. Thus, when the negotiation is completed by the hard negotiator, the intermediary system handling fee to the hotel is T% of the negotiation price B while the handling fee to the customer is W% of the negotiation price B.

The negotiation price C for the gambler negotiator has a discount rate with a wide range of from 0% to 100%. The intermediary handling fee to the hotel is U% of the negotiation price C. The intermediary handling fee to the customer is X% of the negotiation price C. The intermediary handling fees M%, S%, T%, in the table of FIG. 4 decrease in that order, i.e., M)S)T, since the profit of the hotel (seller) decreases as the degree of negotiation increases.

In contrast, the handling fees V% and W% to be charged to the customer (buyer) increase in that order, i.e., V(w, since the customer benefits as the degree of negotiation increases. However, if the intermediary handling fee exceeds the discount price, the customer will end up losing money. Thus, the fees V% and W% are so established that the intermediary handling fee is always lower than the discount rate.

On the other hand, the negotiation efforts by the intermediary server 1 should also be rewarded by increasing an overall charges with decrease of the negotiation price. Thus, the sum of the intermediary handling fees to the hotel (seller) and the customer (buyer) is set to be higher as the final price (reservation price) goes down. Each coefficient M, P, Q, S, T, U, V, W and X is stored in the intermediary handling fee unit 26 of FIG. 2. The distinction of the negotiation prices is not limited to the three types described in the foregoing, but can be two types or four or more types.

For the types of transaction through the negotiation described above, various other factors can also be considered in the negotiation and two or more such factors may be combined. For example, such negotiation factors may include whether a buyer is a group of customers, a long stay or short stay customer, a rush reservation request such as on the same day or a sufficiently earlier request, a stay with family, with breakfast or no breakfast, or two meals, and etc. The customer can initiate negotiation request by selecting one or more such negotiation factors on the display. Thus, the customer may be able to reach a negotiation price that is a multiple of each negotiation factor with an associated negotiation rate.

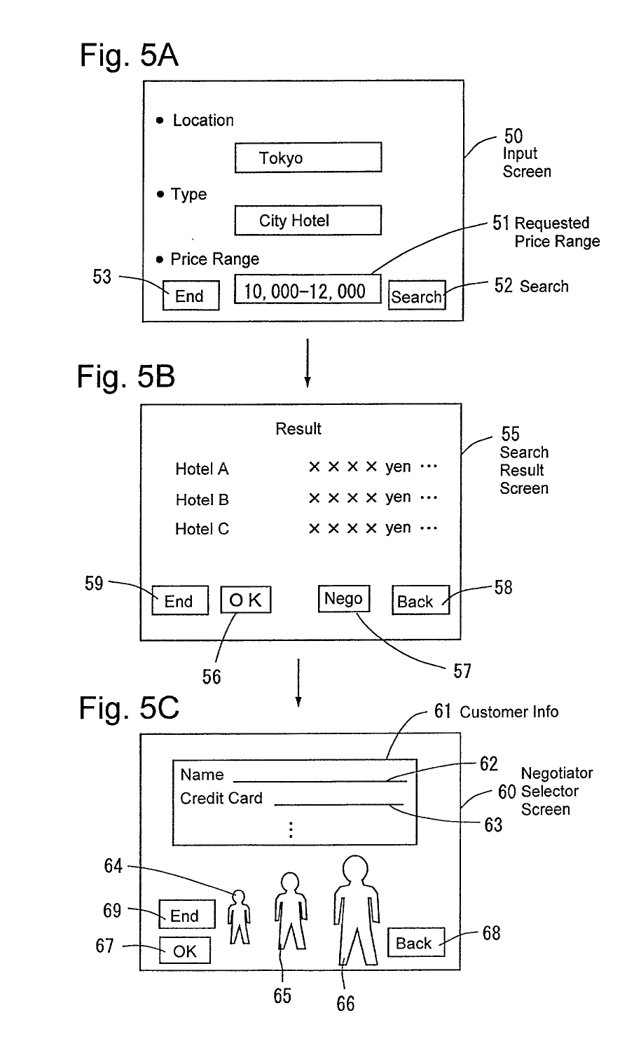

FIGS. 5A-5C show an example of display images on the buyer terminals 6 when conducting a hotel room reservation process based on the data from the transaction intermediary apparatus of the present invention. In this example, in order to simplify the illustration, the input data sent by the customer in the first stage of the transaction is only a desired price range. Namely, as shown by an input display screen 50 of FIG. 5A, it is assumed that the customer input the desired price range of “10,000-12,000 yen” in a desired price range box 51, and pressed a search button 52.

The data retriever 25 of the intermediary server 1 searches for the hotel that matches the desired price range from the regular price database 28, and displays the result on a search result screen 55 of FIG. 5B. As a result, on the search result screen 55, hotels A, B, and C are shown with their regular prices of the hotel rooms. It will not take a long time to display the search result screen 55 after pressing the search button 52 since the data is already stored in the regular price database 28 in the intermediary server 1. If the customer wants to discontinue the reservation procedure in the input screen 50, he/she can end the process by pressing an end button 53.

If the customer can find a hotel that he/she likes in the list on the search result screen 55 of FIG. 5B, the customer sends an intent (acceptance) to agree on the transaction by pressing an OK button 56. On the other hand, if the customer is not satisfied with the search result, he/she can negotiate by pressing a negotiation (Nego) button 57 in FIG. 5B. If a back button 58 is pressed, the display goes back to the previous screen.

When the customer presses the negotiation (Nego) button 57, the intermediary server 1 displays a negotiator selection screen 60 such as shown in FIG. 5C. The negotiator selection screen 60 includes a customer information input area 61. In the negotiation step, the customer is required to pay a handling fee even if he ultimately will not make any hotel reservation. The customer inputs his profile (customer information) in a name area 62 and a credit card number area 63. Thus, an owner of the intermediary server 1 can securely be paid with a handling fee. Since the handling fee is paid from those who enter into the negotiation without making final reservations, the transaction system of the present invention is financially assured, thereby being able to maintain the transaction system for a long period of time.

It is also possible to include a desired price range box similar to that in the input screen 50 of FIG. 5A in the negotiator selection screen 60 so that the customer can input the negotiation price range that is lower than the regular price. The desired price range may be re-entered after selecting the negotiator character. Moreover, in the desired price range, only one price may be entered so that all prices lower than the specified price are searched by the intermediary server 1.

On the negotiator selection screen 60 in FIG. 5C, a novice negotiator character 64, a hard negotiator character 65, and a gambler negotiator character 66 are respectively illustrated. The customer can select one of the negotiator characters. More particularly, the customer can select the negotiator character by clicking one of the desired negotiator characters 64-66 after inputting necessary information in the customer information input area 61, and pressing the OK button 67. This completes the negotiation request for starting the negotiation procedure.

By sending the negotiation request, the customer terminal 6 switches to a screen pre-established for the selected negotiator character. In FIG. 5C, in the case where the customer wants to end the transaction without going into the negotiation process, he/she can end the transaction by pressing the end button 69. When the customer desires to go back to the previous screen, he can return to the previous screen by pressing the back button 68.

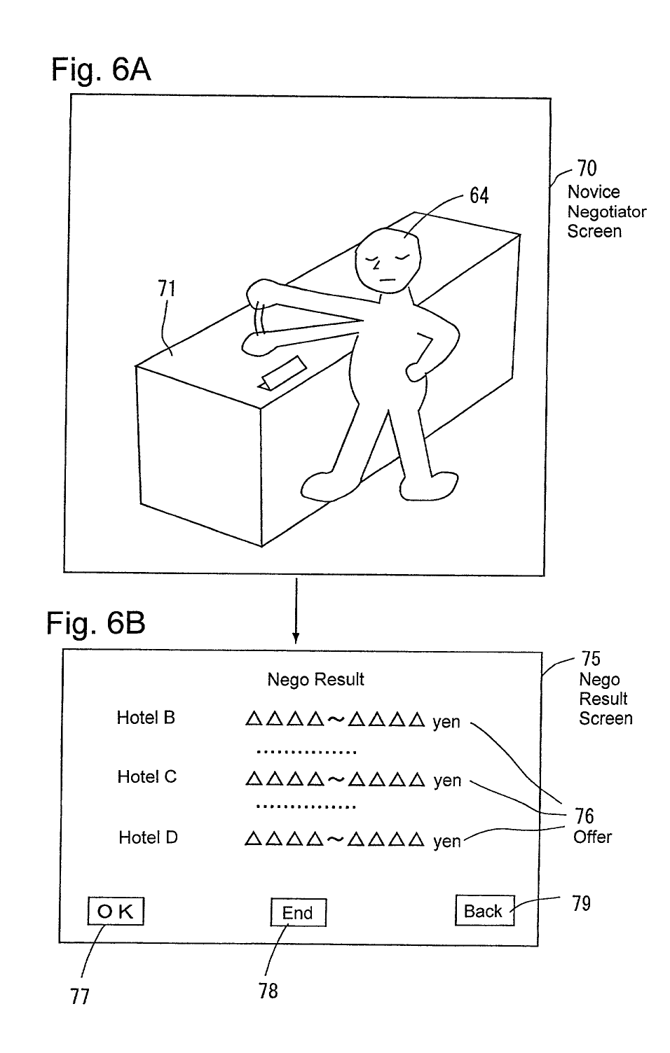

If the customer selects the novice negotiator character 64, in FIG. 6A, a novice negotiator screen 70 will be displayed on the customer terminal. On the novice negotiator screen 70, an animation may be shown which depicting a novice negotiator 64 who is knocking a front desk 71 and negotiating with the hotel. During displaying the animation of FIG. 6A, data including the predetermined negotiation price is taken out from the negotiation price database 29 in the intermediary server 1 and sent to the customer terminal 6. Then, a negotiation result (Nego Result) screen 75 such as shown in FIG. 6B is displayed on the customer terminal 6.

The negotiation result screen 75 shows each list 76 of offer from a hotel B, hotel C, and hotel D. The rooms displayed in each offer list 76 are within the price range of 10,000 yen to 12,000 yen which are discount prices (thus, regular price may be about 15,000 yen to 18,000 yen). In each offer list 76, the precise negotiation price is not shown, but shows only a price range that includes a negotiation price. This serves to mask a precise negotiation price of each hotel to a customer who has merely requested the negotiation. However, if the range of negotiation price is not displayed, or the range of negotiation price is too broad, the customer may have a difficult time in selecting a hotel room.

Therefore, a plurality of price ranges will be used which extends from plus or minus five (5) percent to plus and minus one (1) percent of the negotiation price where each price range includes the exact negotiation price. For example, in the case where the negotiation price is 10,000 yen, the price range of plus/minus 5% is 9,500-10,500 yen, and the price range of plus/minus 1% is 9,900-10,100 yen.

In the negotiation price of 10,000 yen, as an example of negotiation price range display in the offer list 76 of FIG. 6B, “9,900-10,100 yen” will be displayed for the plus/minus 1% price range, and “9,300-10,300 yen” will be displayed for the plus/minus 3% price range. The above price ranges may be set randomly based, for example, on random numbers. Thus, the customer who merely requested the negotiation is unable to know the exact price in the negotiation results from the hotel. Namely, the negotiation price is not completely open to customers (buyers) at this stage, which may be preferable to hotels (sellers) since many hotels do not want to disclose the negotiation price in public. Thus, the transaction apparatus of the present invention can promote membership of hotels (sellers) in the transaction system.

On the other hand, some hotels (sellers) may be wiling to show the precise negotiation price for a customer (buyer) requesting the negotiation. In such a case, the precise negotiation price may be displayed on the negotiation result screen 75. Even if a precise negotiation price is displayed on the negotiation result screen 75, the negotiation price is not known to the customer who has reserved a hotel room with the regular price range. Thus, this transaction apparatus matches the inherent needs of the hotels that do not want to disclose the negotiation prices.

Further, the system may be designed so that a hotel can select either to display the precise negotiation price or not on the negotiation result screen 75. Thus, the transaction apparatus of the present invention can encourage membership of both sellers, i.e., ones that prefers not to disclose the negotiation price, and ones that may disclose the negotiation price. It is also possible that the negotiation result screen 75 displays the precise negotiation price. The negotiation price offered by the hotels may be displayed upon the confirmation of the hotel reservation. Alternatively, in confirming the hotel reservation, the negotiation price requested by the customer may be displayed while the negotiation price offered by the hotel is not displayed at all. The hotel can benefit from this setting because it can complete the transaction with a price higher than the negotiation price the hotel was ready to offer.

On the negotiation result screen 75, when the customer finds a desirable hotel, he/she can select the hotel by, for example, clicking the name of the hotel with a mouse, and press an OK button 77. If the customer wants to end the transaction because, for example, he cannot find a desired hotel room, he can end the process by pressing an end button 78. If the customer wants to return to the previous screen, he can do so by pressing a back button 79.

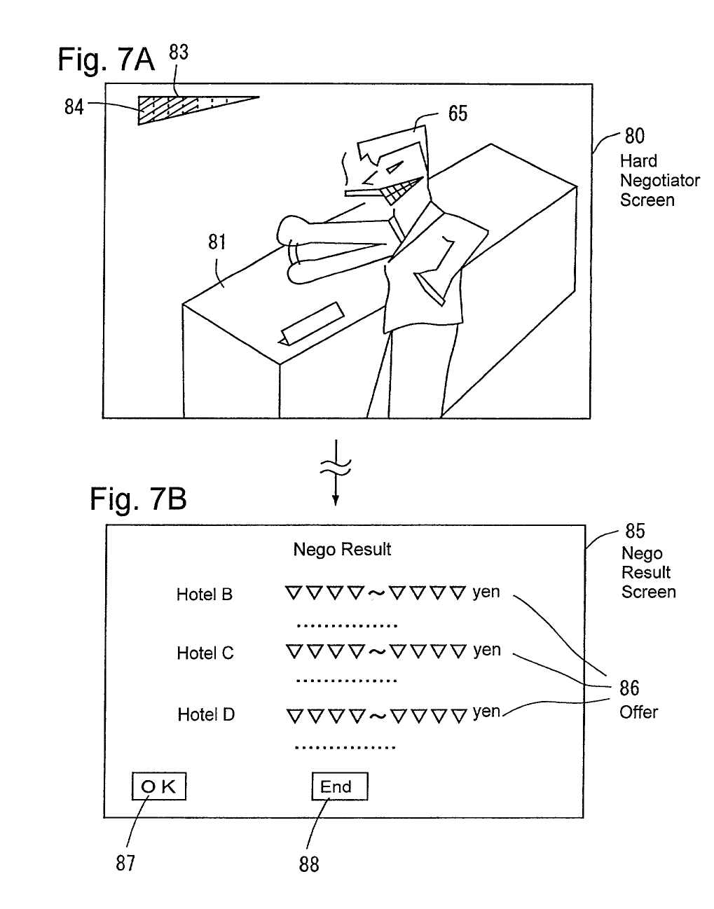

If the customer selects the hard negotiator character 65 on the negotiator selection screen 60 shown in FIG. 5C, the customer terminal 6 displays a hard negotiator screen 80 as shown in FIG. 7A. On the hard negotiator screen 80, an animation is displayed depicting the hard negotiator character 65 who knocking the front desk 81 and negotiating with the hotel. At the upper left of the hard negotiator screen 80, a power level mark 83 shows a level of the negotiation capability of the hard negotiator character 65. In this example, a lamp 84 is lit up to two thirds of an overall length of the power level mark 83. If the lamp 84 illuminates up to the right end of the power level mark 83, then it shows the situation where the hard negotiator character 65 is in the highest negotiation capability. On the other hand, if the lamp 84 decreases to the left end of the power level mark 83, the negotiation capability is in the lowest level.

After displaying the hard negotiator animation for a predetermined time on the hard negotiator screen 80, the reservation procedure is terminated. This is because the negotiation by the hard negotiator requires the customer to wait for the response from the hotel on the negotiation request. When the customer accesses the transaction site managed by the transaction server 1 to make a reservation procedure again within a predetermined time such as 24 hours, the customer terminal 6 displays a negotiation result (Nego Result) screen 85 shown in FIG. 7B. Although not shown, the customer inputs his ID and a password to enter this transaction site. Thus, the negotiation result screen 85 is sent only to the customer, and thus, a third party is not able to see this information from the hotel.

The negotiation result screen 85 shows each offer list 86 corresponding to the hotels B, C D having rooms with large discount rates. In each of the offer lists 86, similar to the negotiation result (Nego Result) screen 75 in FIG. 6B as described above, precise negotiation prices are not displayed, but only price ranges including the negotiation price are displayed. The reason for not showing the exact discount prices is the same as that of the negotiation result screen 75 of the novice negotiator.

When the customer finds a desirable hotel in the offer list 86 on the negotiation result screen 85, the customer clicks the hotel by a mouse, and presses an OK button 87. When the customer wants to end the transaction without going any further, the customer presses an end button 88, thereby terminating the transaction.

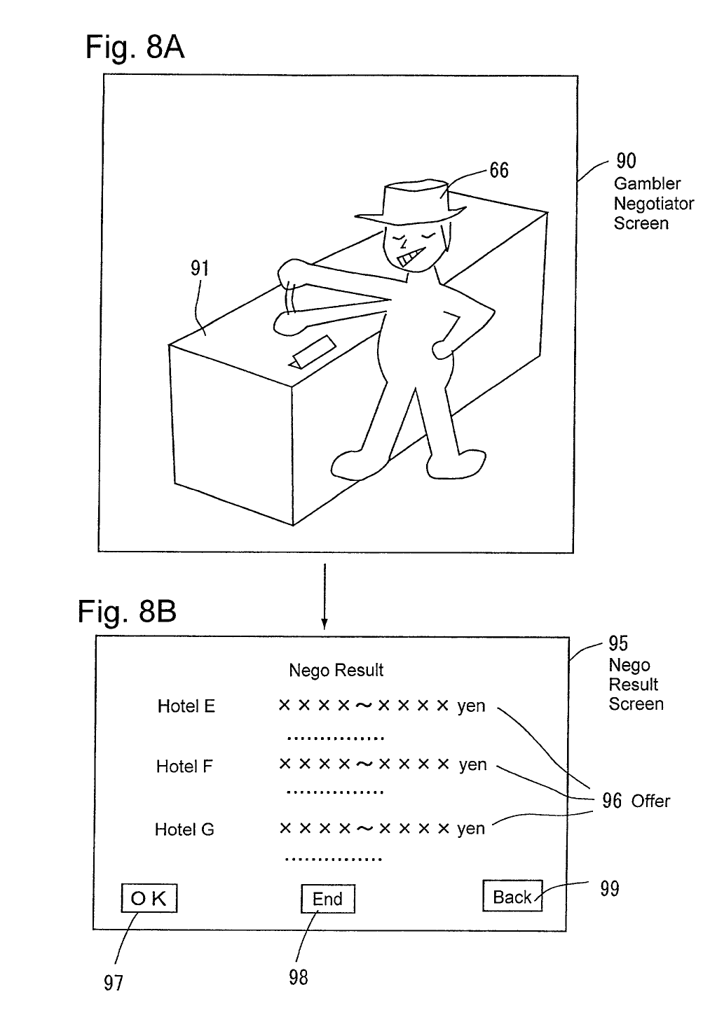

If the customer selects a gambler negotiator character in the negotiator selection screen 60 of FIG. 5, the customer terminal 6 displays a gambler negotiator screen 90 shown in FIG. 8A. On the gambler negotiation screen 90, an animation is displayed depicting the gambler negotiator character 66 who is knocking the front desk 91 and negotiating with the hotel. Then, another animation will be displayed which depicting the gambler negotiator character 66 who is playing a gamble game, such as roulette or cards, with a hotel manager to decide who will win.

Thus, depending on win or loss in the game by the gambler negotiator character 66 against the hotel manager, points may be accumulated which determines the negotiation rate. During this gamble procedure, in the animation shown on the customer terminal 6, the image of the gambler negotiator character 66 or the hotel manager changes depending on the results of the game. For example, the winner's image becomes larger while the loser's image becomes smaller.

At the end of the gamble games between the gamble negotiator character 66 and the hotel manager, a negotiation result screen 95 is displayed on the customer terminal 6 as shown in FIG. 8B. The negotiation result screen 95 shows offer lists 96 of negotiation results from hotels E, F and G which match the negotiation rate determined by the gamble. Similar to the negotiation result screen 75 of FIG. 6B and the negotiation result screen 85 of FIG. 7B, each offer list 96 does not show the exact amount of negotiated prices but only shows price ranges which include the negotiation price. The reason for not showing the exact price from the hotels is the same as described with respect to the novice negotiator character.

When the customer finds a hotel showing the condition he/she likes, the customer clicks the hotel by a mouse and presses an OK button 97. If the customer wants to end the transaction without going any further, he can end the process by pressing an end button 98. When the customer wants to go back to the previous screen, he can do so by pressing a back button 99.

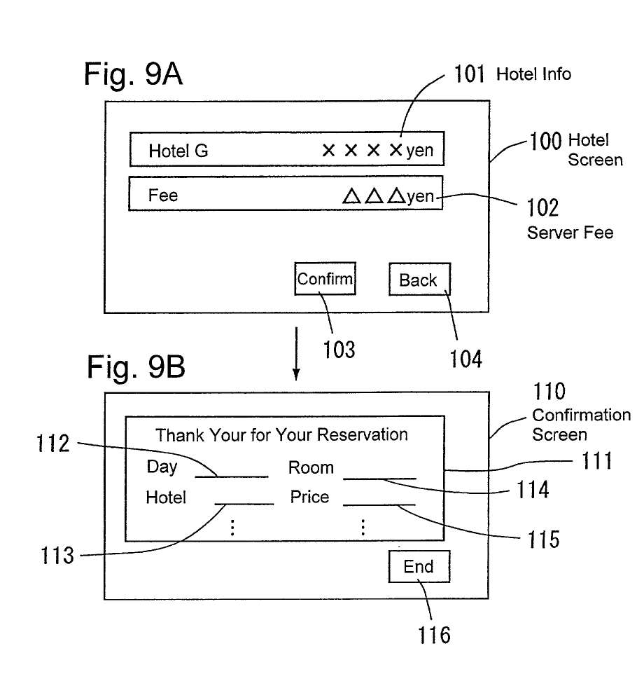

By pressing the OK button in the negotiation result screens of FIGS. 6B, 7B or 8B, the customer terminal 6 displays a specified hotel screen 100 as shown in FIG. 9A. In this example, the specified hotel screen 100 includes a hotel information section 101 which shows the selected hotel (here, hotel G) and the price (room charge), and a server fee section 102. After reading the information on the hotel G, the customer presses a confirmation button 103, which results in a confirmation screen 110 such as shown in FIG. 9B.

In the specified hotel screen 100 of FIG. 9A, if the customer wants to go back to the previous screens, because he wants to select other hotel, the customer can do so by pressing a back (return) button 104. Alternatively, the transaction apparatus can be designed so that the customer cannot go back to the other hotel, such as by not providing the back button 104.

The confirmation screen 110 in FIG. 9B includes a reservation confirmation section 111 by the hotel G. The reservation confirmation section 111 shows a staying day, a hotel name 113, a room type 114, a reservation price 115, and the like. By confirming this information on the confirmation screen 110, the customer presses an end button 116, which ends the hotel reservation process. It is also possible for the customer to only conduct the negotiation without entering into the final reservation.

Although in the foregoing procedure, the transaction apparatus is designed so that the customer can freely select one of the negotiation characters 64, 65 and 66. However, it is also possible to design the transaction apparatus so that the customer must use the negotiation characters in the predetermined order, such as starting from the novice negotiator 64, the hard negotiator 65 and ending the gambler negotiator 66.

Further, it is also possible to automatically assign the negotiator characters 64, 65 and 66 based on the past usage of the transaction apparatus by the customers. For example, for a customer whose past record shows that he/she seldom uses the intermediary transaction apparatus of the present invention, the novice negotiator character 64 may be assigned. In contrast, for a customer who frequently uses the transaction apparatus, the hard negotiator character 65 may be assigned. In such a situation, the gambler negotiator character 66 may be optional and will be optionally assigned to the customer regardless of the past record of use.

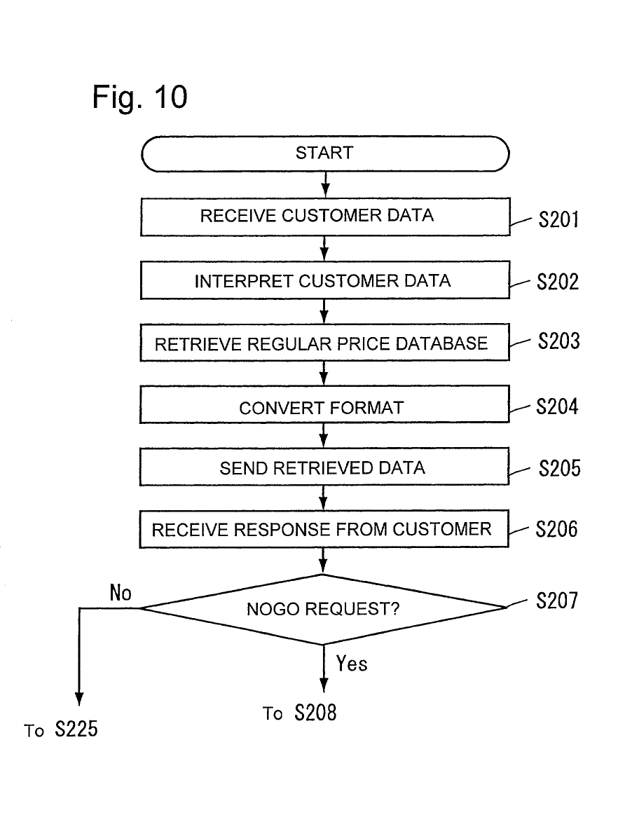

The negotiation process by the intermediary server 1 of the present invention will be described in the following with reference to flow charts of FIGS. 10-12.

Through the customer terminal 6, the customer accesses a hotel reservation site (intermediary server 1). The following process is described after the situation where the customer inputs data indicating his desired date, price, location of a hotel, and a type of hotel (customer purchase condition). The buyer communication section 23 in the intermediary server 1 of FIG. 2 receives the purchase condition data input by the customer in step S201. The data discriminator 24 determines that the input data is the customer purchase condition and analyzes the contents of the input data in step S202.

The data retriever 25 searches for the information in the regular price database 28 which matches the customer purchase condition in step S203. The buy/sell condition processor 33 converts the retrieved data containing the hotel room information to a predetermined format at step S204. The format converted hotel room information is transmitted to the customer terminal 6 through the buyer communication section 23 in step S205.

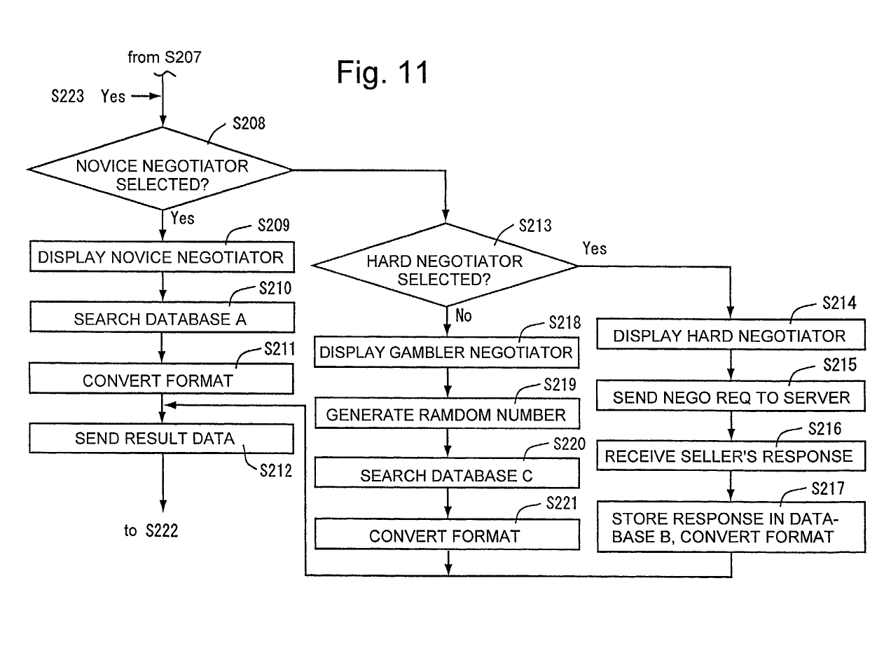

Then the buyer communication section 23 receives a response from the customer in step S206. The data discriminator 24 determines whether the response from the customer is a negotiation request at step S207. If it is not a negotiation request but an intent to agree on the transaction, the process goes to step S225. On the other hand, if the response from the customer is a negotiation request, the data discriminator 24 determines whether the negotiation request has selected the novice negotiator character 64 in step S208 in FIG. 11. When the novice negotiator character 64 is selected, the animation showing the novice negotiator 64 is caused to be displayed on the customer terminal 6 in step S209. Thus, the data retriever 25 retrieves the hotel room information that matches the price range requested by the customer from the negotiation price database (database A) 29 at step S210.

The buy/sell condition processor 33 in the intermediary server 1 converts the retrieved hotel room information into a predetermined display format in step S211. The format converted data from the buy/sell condition processor 33 is transmitted to the customer terminal 6 through the buyer communication section 23 in step S212.

In the case where the novice negotiator character 64 was not selected in step S208, the data discriminator 24 determines whether the hard negotiator character 65 is selected in step S213. When the hard negotiator character 65 is selected, the animation showing the hard negotiator character 65 is caused to be displayed on the customer terminal 6 in step S214. Then the seller communication section 21 sends the negotiation request by the customer to the hotels (sellers) at step S215.

After this procedure, the seller communication section 21 receives responses from the hotels within a predetermined time length, such as 24 hours, in step S216. The responses from the hotels are converted to a predetermined display format and are stored temporarily in the negotiation price database (database B) 30 at step S217. When the customer accesses the transaction site again, the process moves to step S212 to transmit the responses from the hotel retrieved from the database 30 to the customer terminal 6.

In the case where the hard negotiator character is not selected in the step 213, the process determines that the gambler negotiator character 66 is selected by the customer and causes to display the animation of the gambler negotiator character 66 on the customer terminal 6 in step S218. In this situation, the negotiation price will be determined by the random number generator in the negotiation price database 31 at step S219. The data retriever 25 retrieves the hotel room information in the negotiation price database (database C) 31 selected by the random number generator in step S220 which is converted to a predetermined display format in step S221. Then, the hotel room information is sent to the customer terminal 6 in step S212.

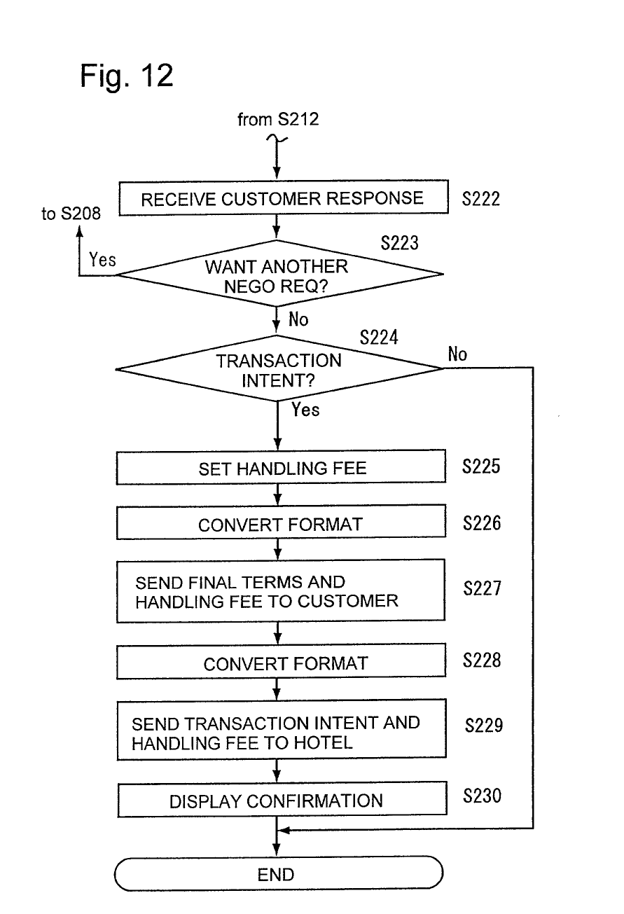

In FIG. 12, the buyer communication section 23 receives a response from the customer in step S222. Then, in step S223, it is determined whether the response from the customer is another negotiation request. If it is another negotiation request, the process goes back to the step S208 (FIG. 11) to repeat the foregoing steps. When the response from the customer is not the negotiation request, the process determines whether the response is an intention to agree on the transaction (transaction intent) in step S224.

If the response from the customer is not the transaction intent, it means that the customer wants to end the process without going any further. Thus, the process ends after a procedure of fee payment. If the response is a transaction intent, the intermediary handling fee unit 26 determines server fees based on predetermined parameters including the negotiation price and seller's type in step S255. The buy/sell condition processor 33 converts the handling fees to a predetermined format in a step S226 and sends this information along with the final condition of the transaction to the customer at step S227.

Upon receiving the transaction intent from the customer, the buy/sell condition processor 33 also converts the handling fees to the hotel to a predetermined format in step S228. The handling fees and the final condition (terms) of the transaction are sent to the hotel terminal 2 through the seller communication section 21 in step S229. Then, the process moves to the confirmation step in which the contents of the hotel reservation is sent to the customer in step S230, thereby ending the overall process. In the case where no transaction intent is received from the customer at step S224, the fee payment procedure may be carried out to receive a predetermined fee from the customer. In such a case, the intermediary handling fee may be set higher than that the case where the customer only negotiates but does not see the hotel information from the hotel.

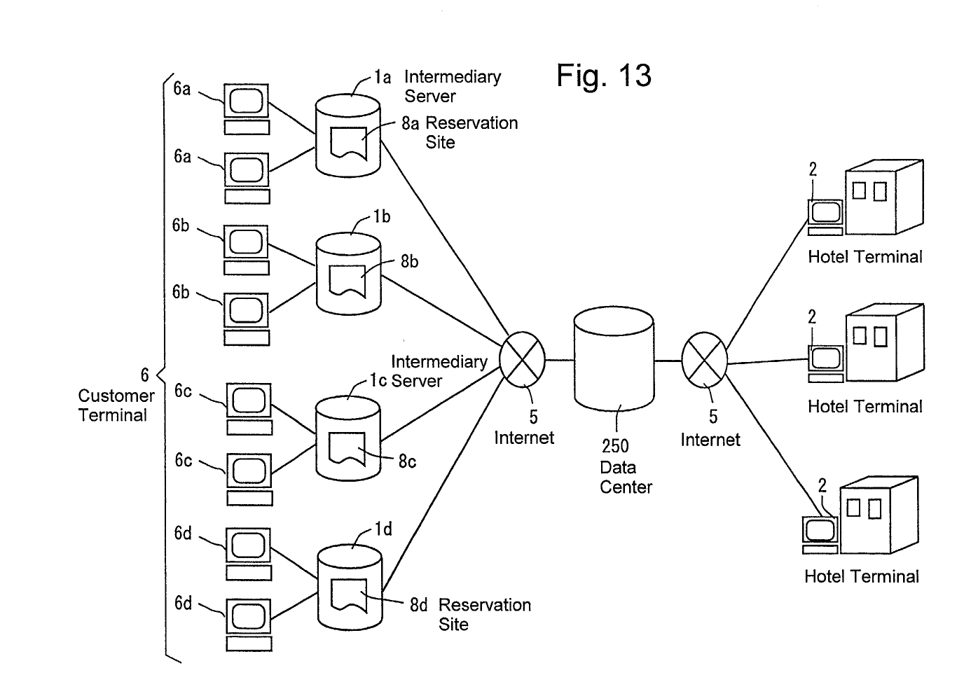

FIG. 13 is a block diagram showing another embodiment of the present invention in which an intermediary transaction system includes a plurality of intermediary servers each having a transaction site, and a data center connecting the plurality of intermediary servers and a plurality of hotels (sellers).

In this example, the intermediary servers 1 are classified into individual member servers 1a and 1b, and corporation member servers 1c and 1d. The individual member server 1a manages and operates a commercial web reservation site 8a and the individual member server 1b manages and operates a commercial web reservation site 8b. The corporation member server 1c manages and operates a corporation exclusive reservation site 8c and the corporation member server id manages and operates a corporation exclusive reservation site 8d.

Each of the commercial web reservation sites 8a and 8bis connected to one or more customer terminals 6a and 6bthrough the Internet 5. Each of the corporation exclusive reservation sites 8c and 8d is connected to one or more customer terminals 6a and 6bthrough dedicated communication lines.

The intermediary servers 1a-1d are connected to the data center 250 through the Internet 5. The data center 250 is a server which collectively manages all of the hotel information involved in the intermediary transaction system. The hotel (seller) terminals 2 are connected to the data center 250 through the Internet 5.

The hotels connected to the data center 250 want to receive different degrees of services from the intermediary transaction system of the present invention. Some hotels want only hotel room reservation service through the Internet, while some hotels may want more intensive hotel managing services including front and accounting works. Some hotels may be a part of chain hotel having its own reservation system.

The data center 250 handles hotel rooms entrusted by the hotels for which reservation are available through communication network such as Internet 5. The data center 250 assigns the predetermined number of such hotel rooms to the reservation sites 8a-8d and manages the hotel room information including the hotel room reservation process. In other words, the data center 250 is a server for performing a hotel room reservation service through the Internet 5.

The data center 250 also has a function to perform a hotel reservation service by each reservation site for the corporation members. In such a situation, the data center 250 sends a response to a customer in response to a negotiation request by the customer. Instead of sending a response to every negotiation request from the customer, the data center 250 may require the member hotels to respond only to a certain type of negotiation request. In stead of storing all of the hotel room information in the data center 250, the intermediary transaction system may be so configured that each reservation site stores the information. Thus, the customers can access the hotel room information at each of the reservation cites 8a-8d and proceed to make reservation through the data center 250.

In this manner, the data center 250 makes it possible that the hotels need not send the hotel room information to each of the reservation cites 8a-8d. Rather, the hotels have to send overall hotel room information to the data center. The data center 250 also saves times of the hotels by obviating needs for each hotel to respond to each and every negotiation request by customers.

The data center 250 has a function of collecting fees on behalf of the intermediary server 1 and the hotels. More particularly, the data center 250 collects deposits through the web from the customers. Such a deposit includes a reservation fee needs to collect when the reservation is completed. Such a reservation fee includes not only a handling fee charged to the customer but also a handling fee charged to the hotel. The data center 250 is able to collect at least one of the handling fees to the customer and the handling fees to the hotel.

The data center 250 may also include a function of collecting fees corresponding to coupons through the web. The data center 250 may also be able to collect other type of fees such as a bond from the customer when the customer requests negotiation. The data center 250 also functions to guarantee credit cards through the web.

As noted above, instead of each intermediary server 1, the data center 250 carries out such jobs of collecting the transaction fees, assigning the handling fees, confirming credit cards and identifying customers and etc. Consequently, it is possible to substantially reduce the load in the intermediary servers 1.

Furthermore, the data center 250 has standardized procedures such as for completion of the hotel reservation or cancellation of the hotel reservation. The standardized procedures are established by regulations applicable to all of the reservation sites. Accordingly, the reservation will be performed based on such standard procedures, thereby avoiding any inconsistency among the hotels or reservation sites. Thus, the intermediary transaction system of the present invention can provide simple and trouble free procedures, resulting in satisfactions to the customers, hotels, and server managers.

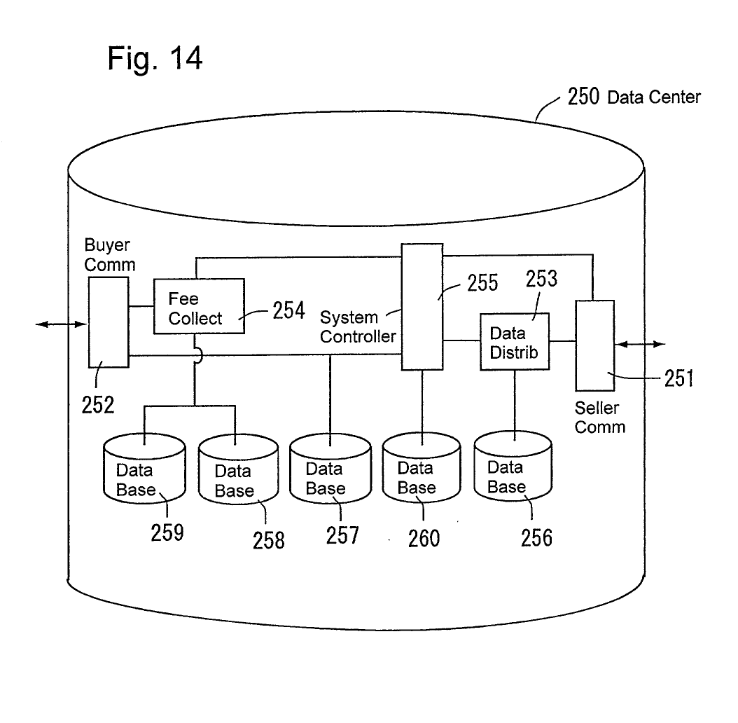

The structure and operation of the data center 250 is further described with reference to the block diagram of FIG. 14. The data center 250 consists of a seller (hotel) communication section 251, a site communication section 252, a data distribution controller 253, a fee collection controller 254, a system controller 255, a distribution information database 256, a hotel room information database 257, a handling fee information database 258, a financial institution information database 259, and a regulation database 260.

The seller communication section 251 collectively receives the hotel room information from the hotels (sellers) and transmits notices of reservation completion and negotiation requests to the hotels. The site communication section 252 receives negotiation requests from the reservation sites 8a-8d in the intermediary servers 1a-1d, customer information including credit card accounts, transaction intentions by customers to agree on transactions, and etc. The site communication section 252 also transmits responses from the hotels and hotel room information from the database 257 to the customers.

The distribution controller 253 distributes the number of hotel rooms available for the reservation purposes to the reservation sites 8a-8d on the basis of the distribution data such as distribution ratios stored in the distribution database 256. It is also possible that the distribution controller 253 distributes the number of hotel rooms to the reservation sites 8a-8d based on the distribution data attached to the information from the hotels regarding the overall number of available hotel rooms.

The fee collection controller 254 determines how much and who to charge the handling fee based on the customer information, customer's intention to complete the transaction or to cancel the transaction, and the like, from the reservation sites 8a-8d. The system controller 255 controls the overall operation of the data center 250 and deals with negotiation requests by the hard negotiator character from the customer through reservation sites 8a-8d. The system controller 255 stores a program for conducting the control operations of each components in the data center 250.

The distribution information database 256 stores distribution ratios for assigning the numbers of hotel rooms to the reservation sites 8a-8d. The distribution ratios will be renewed when the hotels send new distribution ratios to the data center 250.

The hotel room information database 257 stores hotel room information such as regular prices, negotiation prices, room types, and visual image data for each room. Typically, the hotel room information database 257 stores information which is not stored in the intermediary servers 1. For example, when the database in the intermediary servers 1 do not include negotiation prices corresponding to hard negotiation, such negotiation prices are stored in the hotel room information database 257 in the data center 250.

Alternatively, it is possible to store all of the information necessary for the hotel room reservation, such as regular price data and negotiation price data, in the hotel room information database 257 without storing any information in the servers 1. By this arrangement, the amount of data stored in the servers is reduced, which simplifies management of the intermediary servers 1.

The handling fee information database 258 stores data regarding various types of handling fees such as shown in FIG. 3. The financial institution information database 259 stores information regarding the financial institutions such as banks which handle credit cards of the customers. The regulation database 260 stores data regarding regulations standardized in the whole system for such cases as completion of reservation, cancellation of reservation and the like. The handling fees are determined by the regulation data.

The operation of the data center 250 is described in the following with respect to the distribution of the hotel room information, hotel room reservation procedure, collection of handling fees, and the standardized regulation. The seller communication section 251 receives data from the hotels concerning the overall number of hotel rooms available for the reservation through the intermediary transaction system. The distribution controller 253 reads the distribution ratios for the reservation sites 8a-8d from the distribution information database 256 and determines the number of hotel rooms for each reservation site.

The data concerning the number of hotel rooms is transmitted to the reservation sites 8a-8d through the site communication section 252. The total number of hotel rooms noted above may be established separately with respect to regular price data (first offer data) and negotiation price data (second offer data).

The site communication section 252 receives a hard negotiation request (negotiation by the hard negotiator character) from the customer. Then, the system controller 255 reads the hotel room information which corresponds to the hard negotiation request from the hotel room information database 257. The system controller 255 sends the retrieved hotel room information to the corresponding transaction site through the site communication section 252.

The site communication section 252 also receives the credit account information of the customers from the reservation sites 8a-8d. The fee collection controller 254 determines a type of handling fee to be charged to the customers based on the transaction processes by the customers. The fee collection controller 254 reads the fee data regarding the type of handling fee from the handling fee information database 258. Further, based on the customer information including the credit card account, the fee collection controller 254 specifies the financial institution to charge the handling fee to the customer from the financial institution database 259.

Then, through the seller communication section 251, the fee collection controller 254 proceeds to collect the handling fee of the customer from the specified financial institution. During this process, the fee collection controller 254 may confirm whether there remains a fund sufficient to pay the reservation fee in the customer's account in the financial institution. In the case where it is determined that there is not sufficient fund in the account, the fee collection controller 254 sends this information to the corresponding reservation site 8 through the site communication section 252.

The system controller 255 determines the handling fees based on the standard provisions stored in the regulation database 260. Therefore, when there is a change in the regulation, the system controller 255 stores the new regulation in the regulation database 260 and changes the program in the fee collection controller 254. The system controller 255 also revises the data in the handling fee information database 258 and sends the new regulation to the reservation sites 8a-8d.

The operations of the intermediary server 1 and/or the data center 250 are actualized in the program steps which may be embodied in a computer readable storage medium such as a CD ROM or a semiconductor memory, or a floppy disc. Such a storage medium can be separated from the intermediary server or the data center and can be installed in a separate computer to achieve the same operations of the intermediary server and the data center.

More specifically, a storage medium stores a first offer data receiving step for receiving first offer data which includes price data of goods or services provided by at least one seller, a second offer data receiving step for receiving at least one kind of second offer data which has conditions more beneficial to buyers in price or quality than that of the first offer data, a requested condition data receiving step for receiving conditions requested by a buyer which includes at least a price range desired by the buyer for the goods or services, a data retrieving step for retrieving data concerning goods or services which matches the conditions requested by the buyer, a first offer step for offering the data on the goods or services retrieved from the first offer data through the data retrieving step to the buyer, a negotiation request receiving step for receiving at least one negotiation request which requests a transaction condition more beneficial to the buyer in the price or quality than the data retrieved from the first offer data, a second offer step for offering at least one kind of the second offer data to the buyer in response to the negotiation request, a transaction intent receiving step for receiving a transaction intent of the buyer to agree on the transaction after offering the second offer data at least once, and a transaction intent sending step for sending the transaction intent of the buyer to the seller which includes at least a seller who provides the goods or services agreed upon by the buyer. The second offer step adds a negotiation price, which has not been offered to the buyer, to the second offer data sent to the buyer.

By using the storage medium storing the program for achieving the above operation steps, a computer can operate in the same manner as the intermediary server 1 described above. Further, the storage medium may further store the program which include the steps of a negotiator character display step for, upon receiving the negotiation request, displaying a plurality of negotiator characters from a novice negotiation character having the lowest negotiation capability to a hard negotiator character having the highest negotiation capability in this order depending on a number of times of the negotiation request, and a negotiation action display step for displaying actions of the negotiator character on a terminal screen of the buyer.

The present invention is not limited to the embodiments described in the foregoing, but is capable of various modifications without departing from the spirit and scope of the present invention.

For example, in the foregoing example, the desired price range by the customer defines an upper limit and lower limit. However, it is also possible to define only an upper limit of the price range. The hotel room information with a negotiation price is displayed in a sequential order in response to the negotiation request in the above example, however, two or more different negotiation prices can be displayed on the customer terminal at the same time.

In the foregoing example, the hotel room information with negotiation prices are provided freely by the member hotels. However, the system may require that all of the member hotel must provide the hotel room information with negotiation price relative to a predetermined level of negotiation. Further, the intermediary handling fees can be different depending on the type of seller, such as hotels, travel agents, or public organizations.

Instead of inputting the regular price with an amount of currency, it can also be specified by a ratio relative to list price (tariff price). Namely, only the tariff price is defined by the specific amount of money, and the regular price and negotiation price are defined by percentages of the tariff price, such as 30% or 50%. Thus, the negotiation price database 29 may store not the exact negotiation prices but only the percentages of the tariff prices.

The intermediary apparatus may be so arranged that the customer can renew his/her purchase condition such as a price range during the negotiation process. For example, in such an arrangement, after reviewing the offer data retrieved from the regular price database, the customer can search a hotel room with the type of hotel room in the offer data with a new price range defined by the customer. In the above example, the payment procedure of the intermediary handling fees is initiated at the same time of receiving the transaction intent by the customer, however, it can be made after the receipt of such transaction intent.

In the foregoing example, the customer has to provide the customer information such as a credit card account when starting the negotiation request. However, such customer information may not be necessary if the transaction intermediary apparatus can collect the handling fee without the credit card account when the customer decides not to complete the transaction.

For example, in the case where the customer can be specified based on the ID and pass word entered at the time of accessing the reservation site, the handling fee can be collected without the credit card information, when the customer canceled the negotiation procedure. Alternatively, such handling fee after the negotiation request can be added to the membership fee. If it is determined that such a percentage of cancellation of the negotiation is low, the handling fee may be included in the membership fee.

It is also possible to arrange the intermediary apparatus so that two or more offers will be provided to the customer by one hotel when receiving the negotiation request from the customer. For example, when the hotel has two or more hotel rooms within the price range specified by the customer, the hotel can send the hotel room information for such two or more rooms to the customer. Further, the transaction intermediary apparatus of the present invention may be modified so that the transaction intent by the customer can be sent not only to the specified hotel but also other hotels which responded to the negotiation request.

In the case where the data regarding all of the negotiation prices is stored in the intermediary server 1, thus it is unnecessary to request a response from the hotel, the seller communication section 21 may not need to have a function to send the negotiation request from the customer to the hotel.

In the foregoing description, the animation of each of the negotiator characters is illustrated on the customer terminal 6. However, it is also possible to display the negotiator characters by still pictures on the customer terminal 6. Thus, in the examples of FIG. 6A, 7A and 8A, the display images of the negotiation characters can be done both by animations and still pictures.

The transaction intermediary apparatus, method and system of the present invention can be applied to various transactions of goods and services other than the hotel room reservation. For example, the present invention can be applied to the transaction of plane tickets, theater tickets, home electronics appliances, automobiles, houses, furniture, pictures, souvenirs, insurance, and many others.

Although only a preferred embodiment is specifically illustrated and described herein, it will be appreciated that many modifications and variations of the present invention are possible in light of the above teachings and within the purview of the appended claims without departing the spirit and intended scope of the invention.

What is claimed is:

1. A transaction intermediary apparatus with a negotiation capability for trading goods or services between buyers and sellers for achieving buyer driven transactions including transactions resulted from negotiation requests initiated by buyers, comprising:
a first offer data receiving means for receiving first offer data which includes price data of goods or services provided by at least one seller;
a second offer data receiving means for receiving at least one kind of second offer data which has conditions more beneficial to buyers in price or quality than that of the first offer data;
a requested condition data receiving means for receiving conditions requested by a buyer which includes at least a price range desired by the buyer for the goods or services;
a data retrieving means for retrieving data concerning goods or services which matches the conditions requested by the buyer;
a first offer means for offering the data on the goods or services retrieved from the first offer data by the data retrieving means to the buyer;
a negotiation request receiving means for receiving at least one negotiation request which requests a transaction condition more beneficial to the buyer in the price or quality than the data retrieved from the first offer data;
a second offer means for offering at least one kind of the second offer data to the buyer in response to the negotiation request;
a transaction intent receiving means for receiving a transaction intent of the buyer to agree on the transaction after offering the second offer data at least once; and
a transaction intent sending means for sending the transaction intent of the buyer to the seller which at least includes a seller who provides the goods or services agreed upon by the buyer;
wherein the second offer means adds a precise negotiation price, which has not been offered to the buyer, to the second offer data after the buyer sends the transaction intent.

2. A transaction intermediary apparatus as defined in claim 1, wherein the subject of the transaction is hotel room reservation.

3. A transaction intermediary apparatus with a negotiation capability for trading goods or services between buyers and sellers for achieving buyer driven transactions including transactions resulted from negotiation requests initiated by buyers, comprising:
a first offer data receiving means for receiving first offer data which includes price data of goods or services provided by at least one seller;
a second offer data receiving means for receiving at least one kind of second offer data which has conditions more beneficial to buyers in price or quality than that of the first offer data;
a requested condition data receiving means for receiving conditions requested by a buyer which includes at least a price range desired by the buyer for the goods or services;
a data retrieving means for retrieving data concerning goods or services which matches the conditions requested by the buyer;
a first offer means for offering the data on the goods or services retrieved from the first offer data by the data retrieving means to the buyer;
a negotiation request receiving means for receiving at least one negotiation request which requests a transaction condition more beneficial to the buyer in the price or quality than the data retrieved from the first offer data;
a second offer means for offering at least one kind of the second offer data to the buyer in response to the negotiation request;
a transaction intent receiving means for receiving a transaction intent of the buyer to agree on the transaction after offering the second offer data at least once;
a transaction intent sending means for sending the transaction intent of the buyer to the seller which at least includes a seller who provides the goods or services agreed upon by the buyer; and
a confirmation display means for showing the buyer the confirmation display regarding the goods or services reaching the agreement, upon receiving the transaction intent;
wherein the confirmation display by the confirmation display means includes a precise negotiation price data which has not at all been offered or not been clearly offered to the buyer before the buyer sending the transaction intent.

4. A transaction intermediary apparatus as defined in claim 3, wherein the subject of the transaction is hotel room reservation.

5. A transaction intermediary method involving a negotiation capability for trading goods or services between buyers and sellers for achieving buyer driven transactions including transactions resulted from negotiation requests initiated by buyers, comprising the following steps of:
a first offer data receiving step for receiving first offer data which includes price data of goods or services provided by at least one seller;
a second offer data receiving step for receiving at least one kind of second offer data which has conditions more beneficial to buyers in price or quality than that of the first offer data;
a requested condition data receiving step for receiving conditions requested by a buyer which includes at least a price range desired by the buyer for the goods or services;
a data retrieving step for retrieving data concerning goods or services which matches the conditions requested by the buyer;
a first offer step for offering the data on the goods or services retrieved from the first offer data through the data retrieving step to the buyer;
a negotiation request receiving step for receiving at least one negotiation request which requests a transaction condition more beneficial to the buyer in the price or quality than the data retrieved from the first offer data;
a second offer step for offering at least one kind of the second offer data to the buyer in response to the negotiation request;
a transaction intent receiving step for receiving a transaction intent of the buyer to agree on the transaction after offering the second offer data at least once; and
a transaction intent sending step for sending the transaction intent of the buyer to the seller which includes at least a seller who provides the goods or services agreed upon by the buyer;
wherein the second offer step adds a negotiation price, which has not been offered to the buyer, to the second offer data sent to the buyer.

6. A transaction intermediary method as defined in claim 5, wherein the subject of the transaction is hotel room reservation.

7. A transaction intermediary method involving a negotiation capability for trading goods or services between buyers and sellers for achieving buyer driven transactions including transactions resulted from negotiation requests initiated by buyers, comprising the following steps of:
a first offer data receiving step for receiving first offer data which includes price data of goods or services provided by at least one seller;
a second offer data receiving step for receiving at least one kind of second offer data which has conditions more beneficial to buyers in price or quality than that of the first offer data;
a requested condition data receiving step for receiving conditions requested by a buyer which includes at least a price range desired by the buyer for the goods or services;
a data retrieving step for retrieving data concerning goods or services which matches the conditions requested by the buyer;
a first offer step for offering the data on the goods or services retrieved from the first offer data by the data retrieving step to the buyer;
a negotiation receiving step for receiving at least one negotiation request which requests a transaction condition more beneficial to the buyer in the price or quality than the data retrieved from the first offer data;
a second offer step for offering at least one kind of the second offer data to the buyer in response to the negotiation request;
a transaction intent receiving means for receiving a transaction intent of the buyer to agree on the transaction after offering the second offer data at least once;
a transaction intent sending step for sending the transaction intent of the buyer to the seller which includes at least a seller who provides the goods or services agreed upon by the buyer; and
a confirmation display step for showing the buyer the confirmation display regarding the goods or services that have reached the agreement, upon receiving the transaction intent;
wherein the confirmation display in the confirmation display step includes a negotiation price data which has not at all been offered or not clearly been offered to the buyer.

8. A transaction intermediary method as defined in claim 7, wherein the subject of the transaction is hotel room reservation.

9. A transaction intermediary apparatus with a negotiation capability for trading goods or services between buyers and sellers for achieving buyer driven transactions including transactions resulted from negotiation requests initiated by buyers, comprising:
a first offer data receiving means for receiving first offer data which includes price data of goods or services provided by at least one seller;
a second offer data receiving means for receiving at least one kind of second offer data which has conditions more beneficial to buyers in price or quality than that of the first offer data;
a requested condition data receiving means for receiving conditions requested by a buyer which includes at least a price range desired by the buyer for the goods or services;
a data retrieving means for retrieving data concerning goods or services which matches the conditions requested by the buyer;
a first offer means for offering the data on the goods or services retrieved from the first offer data by the data retrieving means to the buyer;
a negotiation request receiving means for receiving at least one negotiation request which requests a transaction condition more beneficial to the buyer in the price or quality than the data retrieved from the first offer data;
a negotiator character display means for displaying a plurality of negotiator characters each having a different negotiation capability from one another upon receiving the negotiation request;
a negotiator character selection receiving means for receiving a selected negotiator character from the buyer;
a negotiation action display means for displaying actions of the selected negotiator character on a terminal screen of the buyer;
a second offer means for offering at least one kind of the second offer data to the buyer after the actions of the selected negotiator character;
a transaction intent receiving means for receiving a transaction intent of the buyer to agree on the transaction after offering the second offer data at least once; and
a transaction intent sending means for sending the transaction intent of the buyer to the seller which at least includes a seller who provides the goods or services agreed upon by the buyer.

10. A transaction intermediary apparatus as defined in claim 9, wherein a waiting time required before offering the second offer data is proportional to a degree of the negotiation capability of the negotiator character in that the higher the negotiation capability, the longer it becomes the waiting time.

11. A transaction intermediary apparatus as defined in claim 9, wherein the second offer means sends a predetermined negotiation price to the buyer when the negotiation character display means displays the novice negotiation character; and
wherein the transaction intermediary apparatus further including a negotiation request transmission means to send the negotiation request to the seller when the negotiation character display means displays the hard negotiator character; and
wherein the second offer means offers the second offer data received from the seller in response to the negotiation request to the buyer.

12. A transaction intermediary apparatus as defined in claim 9, wherein the negotiation character display means displays a gambler negotiator character in response to the selection by the buyer where the gamble negotiator character determines a degree of negotiation through a gamble; and
wherein the second offer means offers the degree of negotiation to the buyer where the degree of negotiation is determined by a random number or a score of a game generated by a program prepared in advance.

13. A transaction intermediary apparatus as defined in claim 9, wherein the subject of the transaction is hotel room reservation.

14. A transaction intermediary apparatus with a negotiation capability for trading goods or services between buyers and sellers for achieving buyer driven transactions including transactions resulted from negotiation requests initiated by buyers, comprising:
a first offer data receiving means for receiving first offer data which includes price data of goods or services provided by at least one seller;
a second offer data receiving means for receiving at least one kind of second offer data which has conditions more beneficial to buyers in price or quality than that of the first offer data;
a requested condition data receiving means for receiving conditions requested by a buyer which includes at least a price range desired by the buyer for the goods or services;
a data retrieving means for retrieving data concerning goods or services which matches the conditions requested by the buyer;
a first offer means for offering the data on the goods or services retrieved from the first offer data by the data retrieving means to the buyer;
a negotiation request receiving means for receiving at least one negotiation request which requests a transaction condition more beneficial to the buyer in the price or quality than the data retrieved from the first offer data;
a negotiator character display means for, upon receiving the negotiation request, displaying a plurality of negotiator characters from a novice negotiation character having the lowest negotiation capability to a hard negotiator character having the highest negotiation capability in this order depending on a number of times of the negotiation request;
a negotiation action display means for displaying actions of the negotiator character on a terminal screen of the buyer;
a second offer means for offering at least one kind of the second offer data to the buyer after the actions of the negotiator character;
a transaction intent receiving means for receiving a transaction intent of the buyer to agree on the transaction after offering the second offer data at least once; and
a transaction intent sending means for sending the transaction intent of the buyer to the seller which at least includes a seller who provides the goods or services agreed upon by the buyer.

15. A transaction intermediary apparatus as defined in claim 14, wherein a waiting time required before offering the second offer data is proportional to a degree of the negotiation capability of the negotiator character in that the higher the negotiation capability, the longer it becomes the waiting time.

16. A transaction intermediary apparatus as defined in claim 14, wherein the second offer means sends a predetermined negotiation price to the buyer when the negotiation character display means displays the novice negotiation character; and
wherein the transaction intermediary apparatus further including a negotiation request transmission means to send the negotiation request to the seller when the negotiation character display means displays the hard negotiator character; and
wherein the second offer means offers the second offer data received from the seller in response to the negotiation request to the buyer.

17. A transaction intermediary apparatus as defined in claim 14, wherein the negotiation character display means displays a gambler negotiator character in response to the selection by the buyer where the gamble negotiator character determines a degree of negotiation through a gamble; and
wherein the second offer means offers the degree of negotiation to the buyer where the degree of negotiation is determined by a random number or a score of a game generated by a program prepared in advance.

18. A transaction intermediary apparatus as defined in claim 14, wherein the subject of the transaction is hotel room reservation.

19. A transaction intermediary method involving a negotiation capability for trading goods or services between buyers and sellers for achieving buyer driven transactions including transactions resulted from negotiation requests initiated by buyers, comprising the following steps of:
a first offer data receiving step for receiving first offer data which includes price data of goods or services provided by at least one seller;
a second offer data receiving step for receiving at least one kind of second offer data which has conditions more beneficial to buyers in price or quality than that of the first offer data;
a requested condition data receiving step for receiving conditions requested by a buyer which includes at least a price range desired by the buyer for the goods or services;
a data retrieving step for retrieving data concerning goods or services which matches the conditions requested by the buyer;
a first offer step for offering the data on the goods or services retrieved from the first offer data by the data retrieving step to the buyer;
a negotiation request receiving step for receiving at least one negotiation request which requests a transaction condition more beneficial to the buyer in the price or quality than the data retrieved from the first offer data;
a negotiator character display step for displaying a plurality of negotiator characters each having a different negotiation capability from one another upon receiving the negotiation request;
a negotiator character selection receiving step for receiving a selected negotiator character from the buyer;
a negotiation action display step for displaying actions of the selected negotiator character on a terminal screen of the buyer;
a second offer step for offering at least one kind of the second offer data to the buyer after the actions of the selected negotiator character;
a transaction intent receiving step for receiving a transaction intent of the buyer to agree on the transaction after offering the second offer data at least once; and
a transaction intent sending step for sending the transaction intent of the buyer to the seller which at least includes a seller who provides the goods or services agreed upon by the buyer.

20. A transaction intermediary method as defined in claim 19, wherein the subject of the transaction is hotel room reservation.

21. A transaction intermediary method involving a negotiation capability for trading goods or services between buyers and sellers for achieving buyer driven transactions including transactions resulted from negotiation requests initiated by buyers, comprising the following steps of:
a first offer data receiving step for receiving first offer data which includes price data of goods or services provided by at least one seller;
a second offer data receiving step for receiving at least one kind of second offer data which has conditions more beneficial to buyers in price or quality than that of the first offer data;
a requested condition data receiving step for receiving conditions requested by a buyer which includes at least a price range desired by the buyer for the goods or services;
a data retrieving step for retrieving data concerning goods or services which matches the conditions requested by the buyer;
a first offer step for offering the data on the goods or services retrieved from the first offer data by the data retrieving step to the buyer;
a negotiation request receiving step for receiving at least one negotiation request which requests a transaction condition more beneficial to the buyer in the price or quality than the data retrieved from the first offer data;
a negotiator character display step for, upon receiving the negotiation request, displaying a plurality of negotiator characters from a novice negotiation character having the lowest negotiation capability to a hard negotiator character having the highest negotiation capability in this order depending on a number of times of the negotiation request;
a negotiation action display step for displaying actions of the negotiator character on a terminal screen of the buyer;
a second offer step for offering at least one kind of the second offer data to the buyer after the actions of the negotiator character;
a transaction intent receiving step for receiving a transaction intent of the buyer to agree on the transaction after offering the second offer data at least once; and
a transaction intent sending step for sending the transaction intent of the buyer to the seller which at least includes a seller who provides the goods or services agreed upon by the buyer.

22. A transaction intermediary method as defined in claim 21, wherein the subject of the transaction is hotel room reservation.

23. A transaction intermediary system with a negotiation capability for trading goods or services between buyers and sellers for achieving buyer driven transactions including transactions resulted from negotiation requests initiated by buyers, comprising:
a plurality of seller data terminals for inputting and outputting data by sellers who want to sell goods or services;
a plurality of buyer data terminals for inputting and outputting data by buyers who want to buy goods or services;
a plurality of transaction intermediary apparatuses provided between the seller data terminals and the buyer data terminals for assisting trade of goods or services between buyers and sellers including negotiation therebetween;
a data center provided between the transaction intermediary apparatuses and the seller data terminals for distributing data input through the seller data terminals to a plurality of transaction sites operated by the transaction intermediary apparatuses;
wherein the data center operates the following steps of:
receiving summary data which summarizes first offer data which includes price data of goods or services provided by at least one seller which is installed in the plurality of transaction sites;
distributing the summary data based on distribution ratios predetermined or transmitted from the sellers and sending the distributed first offer data to the transaction sites;
receiving second summary data which summarizes at least one kind of second offer data which has conditions more beneficial to buyers in price or quality than that of the first offer data; and
distributing the second summary data based on distribution ratios predetermined or transmitted from the sellers and sending the distributed second offer data to the transaction sites;
wherein each of the transaction intermediary apparatuses operates the following steps of:
receiving conditions requested by a buyer which includes at least a price range desired by the buyer for the goods or services;
retrieving data concerning goods or services which matches the conditions requested by the buyer;
offering the data on the goods or services retrieved from the first offer data by the data retrieving step to the buyer;
receiving at least one negotiation request which requests a transaction condition more beneficial to the buyer in the price or quality than the data retrieved from the first offer data;
offering at least one kind of the second offer data to the buyer in response to the negotiation request;
receiving a transaction intent of the buyer to agree on the transaction after offering the second offer data at least once; and
sending the transaction intent of the buyer to the sellers which at least includes a seller who provides the goods or services agreed upon by the buyer.

24. A transaction intermediary system with a negotiation capability for trading goods or services between buyers and sellers for achieving buyer driven transactions including transactions resulted from negotiation requests initiated by buyers, comprising:
a plurality of seller data terminals for inputting and outputting data by sellers who want to sell goods or services;
a plurality of buyer data terminals for inputting and outputting data by buyers who want to buy goods or services;
a plurality of transaction intermediary apparatuses provided between the seller data terminals and the buyer data terminals for assisting trade of goods or services between buyers and sellers including negotiation therebetween;
a data center provided between the transaction intermediary apparatuses and the seller data terminals for sending, on behalf of the sellers, conclusion of transaction to transaction sites operated by the transaction intermediary apparatuses;
wherein the data center operates the following steps of:
receiving first offer data which includes price data of goods or services provided by at least one seller and second offer data which has conditions more beneficial to buyers in price or quality than that of the first offer data;
sending the first offer data and the second offer data to transaction intermediary apparatuses;
wherein each of the transaction intermediary apparatuses operates the following steps of:
receiving conditions requested by a buyer which includes at least a price range desired by the buyer for the goods or services;
retrieving data concerning goods or services which matches the conditions requested by the buyer;
offering the data on the goods or services retrieved from the first offer data by the data retrieving step to the buyer;
receiving at least one negotiation request which requests a transaction condition more beneficial to the buyer in the price or quality than the first offer data;
sending at least one negotiation request by the buyer to the data center;
receiving the second offer data from the data center at least once; and
receiving a transaction intent of the buyer to agree on the transaction and sending the transaction intent of the buyer to the data center;
wherein the data center transmits the transaction intent received by the transaction intermediary apparatuses to the seller data terminals.

25. A transaction intermediary system with a negotiation capability for trading goods or services between buyers and sellers for achieving buyer driven transactions including transactions resulted from negotiation requests initiated by buyers, comprising:
a plurality of seller data terminals for inputting and outputting data by sellers who want to sell goods or services;
a plurality of buyer data terminals for inputting and outputting data by buyers who want to buy goods or services;
a plurality of transaction intermediary apparatuses provided between the seller data terminals and the buyer data terminals for assisting trade of goods or services between buyers and sellers including negotiation therebetween;
a data center provided between the transaction intermediary apparatuses and the seller data terminals for collecting, on behalf of the transaction sites operated by the transaction intermediary apparatuses, necessary fees for transaction from buyers;
wherein each of the transaction intermediary apparatuses operates the following steps of:
receiving first offer data which includes price data of goods or services provided by at least one seller and second offer data which has conditions more beneficial to buyers in price or quality than that of the first offer data;
sending the first offer data and the second offer data to the buyer data terminals;
receiving conditions requested by a buyer which includes at least a price range desired by the buyer for the goods or services;
retrieving data concerning goods or services which matches the conditions requested by the buyer;
offering the data on the goods or services retrieved from the first offer data by the data retrieving step to the buyer;
receiving at least one negotiation request which requests a transaction condition more beneficial to the buyer in the price or quality than the first offer data, and at the same time, receiving credit account data of the buyer;
sending at least one negotiation request by the buyer to the seller data terminals;
receiving the second offer data from the seller data terminals at least once; and
receiving a transaction intent of the buyer to agree on the transaction and sending the transaction intent of the buyer to the seller data terminal;
wherein the data center receives the credit account data of the buyer and collects at least one of negotiation request bond involved in receiving the negotiation request, option fees involved in reserving the transaction of goods or services, and transaction fee involved in concluding the transaction, from at least one of the buyer and seller.
